(19) United States
(12) Patent Application Publication
(10) Pub. No.: US 2025/0201159 A1
(43) Pub. Date: Jun. 19, 2025

(54) ELECTRONIC DEVICE INCLUDING FLEXIBLE DISPLAY AND METHOD FOR CONTROLLING SAME

(71) Applicant: Samsung Electronics Co., Ltd., Suwon-si (KR)

(72) Inventors: Joohoon EOM, Suwon-si (KR); Yangwook KIM, Suwon-si (KR); Jihye PARK, Suwon-si (KR); Soohyun SEO, Suwon-si (KR); Hyungmin LEE, Suwon-si (KR); Heetak LEE, Suwon-si (KR); Inchan SONG, Suwon-si (KR); Sujeong CHO, Suwon-si (KR); Hyoungtak CHO, Suwon-si (KR); Bonghak CHOI, Suwon-si (KR)

(21) Appl. No.: 18/960,721

(22) Filed: Nov. 26, 2024

Related U.S. Application Data
(63) Continuation of application No. PCT/KR2024/018632, filed on Nov. 22, 2024.

(30) Foreign Application Priority Data
Dec. 13, 2023 (KR) 10-2023-0180406
Jan. 26, 2024 (KR) 10-2024-0012085

(51) Int. Cl. G09G 3/00

(52) U.S. Cl. CPC G09G 3/035; G09G 2340/02; G09G 2354/00

(57) ABSTRACT

An electronic device is provided. The electronic device includes a housing, a flexible display in which a size of a display area visible from outside of the electronic device is variable from a first size to a second size based on moving of at least part of the housing, memory storing one or more computer programs, and one or more processors communicatively coupled to the flexible display and the memory, wherein the one or more computer programs include computer-executable instructions that, when executed by the one or more processors individually or collectively, cause the electronic device to display an execution screen of a first application in a first area of the flexible display in a state that the size of the display area is in the first size, while the display area is changed from the first size to the second size, display at least a portion of the execution screen of the first application or a simplified screen of the execution screen of the first application, in a second area including at least a portion of the first area, and while the size of the display area is changed from the first size to the second size, display an execution screen of a second application, corresponding to the size of the display area, in a third area including at least a portion of a display area newly visible from the outside of the electronic device, and wherein a velocity at which the execution screen of the second application is displayed, corresponding to the size of the display area, is different from a velocity at which a size of the display area is changed.

### CROSS-REFERENCE TO RELATED APPLICATION(S)

This application is a continuation application, claiming priority under § 365 (c), of an International application No. PCT/KR2024/018632, filed on Nov. 22, 2024, which is based on and claims the benefit of a Korean patent application number 10-2023-0180406, filed on Dec. 13, 2023, in the Korean Intellectual Property Office, and of a Korean patent application number 10-2024-0012085, filed on Jan. 26, 2024, in the Korean Intellectual Property Office, the disclosure of each of which is incorporated by reference herein in its entirety.

### TECHNICAL FIELD

The disclosure relates to an electronic device including a flexible display and a method of operating the same.

### BACKGROUND ART

As the demand for mobile communication increases and, on the other hand, as the integration of electronic devices increases, the portability of electronic devices, such as mobile communication terminals may be improved, and the convenience of using multimedia functions may be improved. For example, the electronic device may be miniaturized while maintaining the function of an input device by replacing the traditional mechanical (button-type) keypad by a display with an integrated touch screen function. For example, as the mechanical keypad is removed from the electronic device, the portability of the electronic device may be improved. In another embodiment of the disclosure, if the display is expanded by the area where the mechanical keypad is removed, an electronic device including a touch screen function may provide a larger screen than an electronic device including a mechanical keypad even if it has the same size and weight as the electronic device including a mechanical keypad.

In surfing the web or using multimedia functions, it may be more convenient to use an electronic device that outputs a larger screen. Although a larger display may be mounted to the electronic device to output a larger screen, considering the portability of the electronic device, there may be limitations in expanding the size of the display. In an embodiment of the disclosure, a display using an organic light-emitting diode may provide a larger screen while ensuring portability of an electronic device. For example, a display using an organic light-emitting diode (or an electronic device equipped with the same) may implement stable operation even if it is manufactured to be considerably thin, and thus may be mounted to an electronic device in a foldable or bendable form or in a rollable form.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide an electronic device including a flexible display and a method of operating the same.

Additional aspects will be set forth in part in the description which follows and, in part, will be apparent from the description, or may be learned by practice of the presented embodiments.

In accordance with an aspect of the disclosure, an electronic device is provided. The electronic device includes a housing, a flexible display in which a size of a display area visible from outside of the electronic device is variable from a first size to a second size based on moving of at least part of the housing, at least one processor including processing circuitry, and memory storing instructions. According to an embodiment, the instructions that, when executed by the at least one processor individually or collectively, cause the electronic device to display an execution screen of a first application in a first area of the flexible display in a state that the size of the display area is in the first size, while the display area is changed from the first size to the second size, display at least a portion of the execution screen of the first application or a simplified screen of the execution screen of the first application, in a second area including at least a portion of the first area. while the size of the display area is changed from the first size to the second size, display an execution screen of a second application, corresponding to the size of the display area, in a third area including at least a portion of a display area newly visible from the outside of the electronic device, wherein a velocity at which the execution screen of the second application is displayed, corresponding to the size of the display area, is different from a velocity a size of the display area is changed.

In accordance with another aspect of the disclosure, a method of controlling an electronic device is provided. The method includes displaying an execution screen of a first application in a first area of a flexible display when a display area of the flexible display visible from outside of the electronic device is in a first size, displaying at least a portion of the execution screen of the first application or a simplified screen of the execution screen of the first application in a second area including at least a portion of the first area while the display area is changed from the first size to a second size, and displaying an execution screen of a second application, corresponding to the size of the display area, in a third area including at least a portion of the display area newly visible from the outside of the electronic device while the display area is changed from the first size to the second size, wherein a velocity at which the execution screen of the second application is displayed, corresponding to the size of the display area, is different from a velocity at which the size of the display area of the flexible display is changed.

In accordance with another aspect of the disclosure, one or more non-transitory computer-readable storage media storing computer-executable instructions that, when executed by one or more processors individually or collectively, cause an electronic device to perform operations are provided. The operations include displaying an execution screen of a first application in a first area of a flexible display when a display area of the flexible display visible from outside of the electronic device is in the first size, displaying at least a portion of the execution screen of the first application or a simplified screen of the execution screen of the first application in a second area including at least a portion of the first area while the display area is changed from the first size to a second size, and displaying an execution screen of a second application in a third area including at least a portion of the display area newly visible from the outside of the electronic device while the display area is changed from the first size to the second size, wherein a velocity at which the execution screen of the second application is displayed is different from a velocity at which the flexible display moves.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a diagram showing a state in which a second display area of a display is received inside a housing according to an embodiment of the disclosure;

FIG. 3 is a diagram showing a state in which a second display area of a display is exposed to the outside of a housing according to an embodiment of the disclosure;

FIG. 4 is an exploded perspective view of an electronic device according to an embodiment of the disclosure;

FIG. 5A is a cross-sectional view taken along line A-A′ in FIG. 2 according to an embodiment of the disclosure;

FIG. 5B is a cross-sectional view taken along line B-B′ in FIG. 3 according to an embodiment of the disclosure;

FIG. 6 is a flowchart illustrating an operation in which an electronic device executes a multi-window function while a display area of a flexible display is changed according to an embodiment of the disclosure;

FIG. 7 is a diagram illustrating an area of a multi-window, based on a change in a display area of a flexible display of an electronic device, according to an embodiment of the disclosure;

FIG. 8 is a diagram illustrating a change velocity of a display area of a flexible display and a movement velocity of each area of a multi-window in an electronic device according to an embodiment of the disclosure;

FIG. 9A is a flowchart illustrating an operation in which an electronic device executes a multi-window function while a display area of a flexible display is changed according to an embodiment of the disclosure;

FIG. 9B is a diagram illustrating an operation of an electronic device when a display area of a flexible display is in a second size according to an embodiment of the disclosure;

FIG. 9C is a diagram illustrating an operation of an electronic device when a display area of a flexible display is in a second size according to an embodiment of the disclosure;

FIG. 9D is a diagram illustrating an operation of an electronic device when a display area of a flexible display is in a second size according to an embodiment of the disclosure;

FIG. 10 is a diagram illustrating an operation of generating a third area for a multi-window function while a display area of a flexible display is changed in an electronic device according to an embodiment of the disclosure;

FIG. 11A is a diagram illustrating an operation in which a display area of a flexible display is changed while a camera application is running in an electronic device according to an embodiment of the disclosure;

FIG. 11B is a diagram illustrating an operation in which a display area of a flexible display is changed while a camera application is running in an electronic device according to an embodiment of the disclosure;

FIG. 12A is a diagram illustrating an operation in which a display area of a flexible display is changed based on a user input while a notification message is displayed in an electronic device according to an embodiment of the disclosure;

FIG. 12B is a diagram illustrating an operation in which a display area of a flexible display is changed based on a user input while a notification message is displayed in an electronic device according to an embodiment of the disclosure;

FIG. 13 is a diagram illustrating an area of a multi-window, based on a change in a display area of a flexible display, in an electronic device according to an embodiment of the disclosure;

FIG. 14 is a diagram illustrating an operation in which a display area of a flexible display is changed based on a user input while a notification user interface (UI) is displayed in an electronic device according to an embodiment of the disclosure;

FIG. 15 is a diagram illustrating an operation in which a display area of a flexible display is changed based on a user input while a notification UI is displayed in an electronic device according to an embodiment of the disclosure;

FIG. 16A is a flowchart illustrating an operation of an electronic device when a user input for changing a display area of a flexible display is received according to an embodiment of the disclosure;

FIG. 16B is a flowchart illustrating an operation of an electronic device when a user input for changing a display area of a flexible display is received according to an embodiment of the disclosure;

FIG. 17A is a diagram illustrating an operation of an electronic device when a size of a display area of a flexible display is reduced according to an embodiment of the disclosure;

FIG. 17B is a diagram illustrating an operation of an electronic device when a user input for displaying a recently executed application is received after a size of a display area of a flexible display is reduced according to an embodiment of the disclosure;

FIG. 17C is a diagram illustrating an operation of an electronic device depending on a button selected when a display area of a flexible display is in a second size according to an embodiment of the disclosure; and

FIG. 17D is a diagram illustrating an operation of adjusting a displayed boundary when a display area of a flexible display is in a second size in an electronic device according to an embodiment of the disclosure.

Throughout the drawings, it should be noted that like reference numbers are used to depict the same or similar elements, features, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

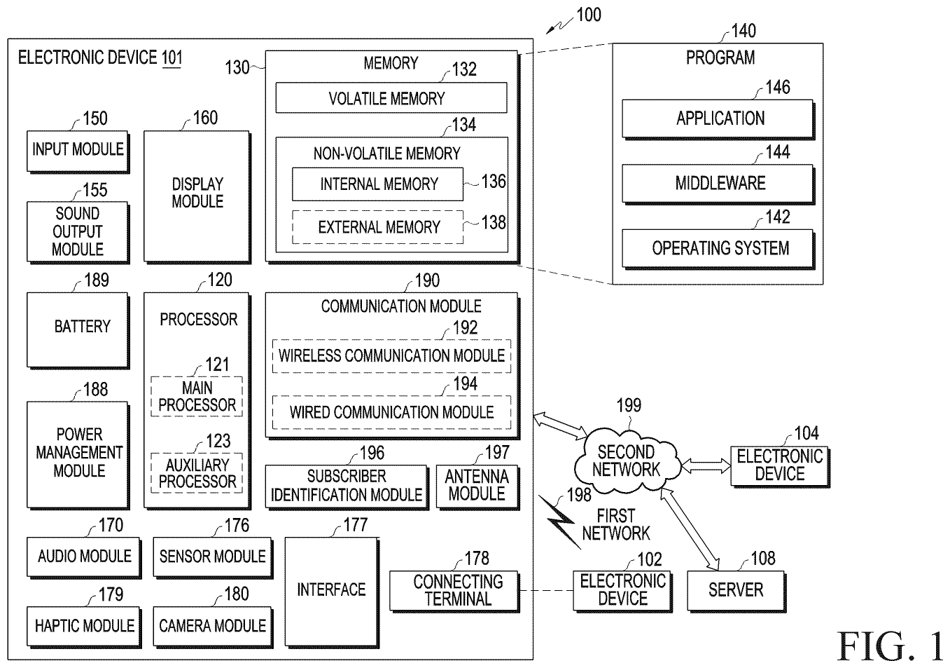

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to an embodiment of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

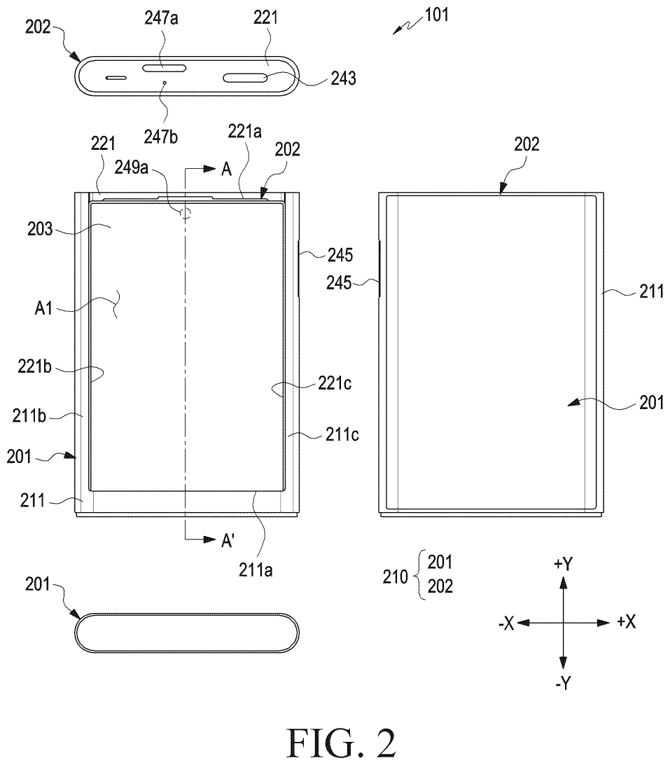

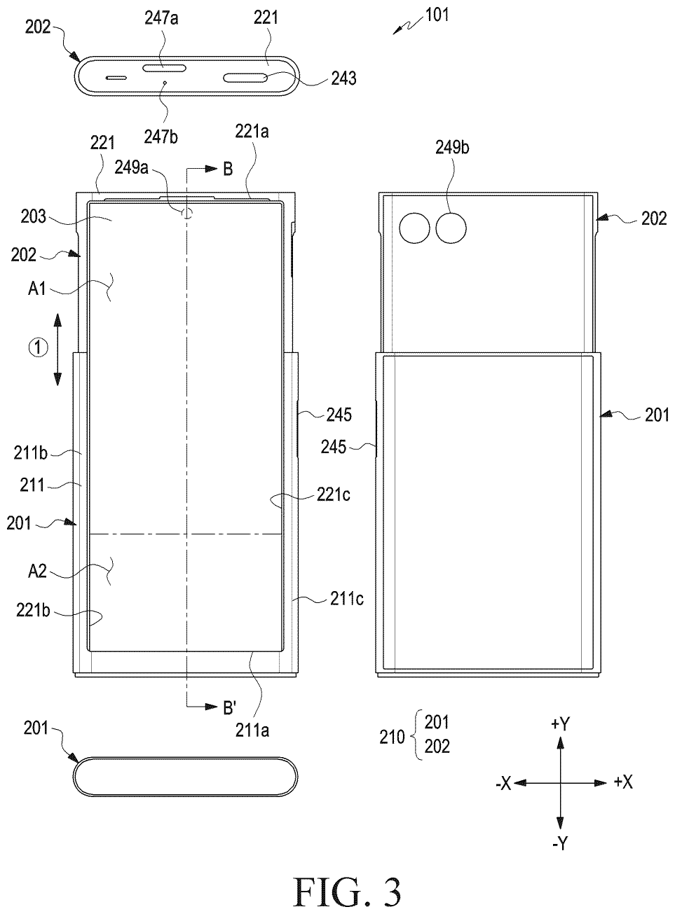

FIG. 2 is a diagram showing a state in which a second display area of a display is received inside a housing according to an embodiment of the disclosure. FIG. 3 is a diagram showing a state in which a second display area of a display is exposed to the outside of a housing according to an embodiment of the disclosure.

FIGS. 2 and 3 show a structure in which a display 203 (e.g., a flexible display or a rollable display) is expanded in a longitudinal direction (e.g., the +Y direction) when viewed from the front of an electronic device 101. However, the expansion direction of the display 203 is not limited to one direction (e.g., the +Y direction). For example, the expansion direction of the display 203 may be designed to be an upward direction (the +Y direction), a rightward direction (e.g., the +X direction), a leftward direction (e.g., −X direction), and/or a downward direction (e.g., the −Y direction).

The state shown in FIG. 2 may be referred to as a closed state of the electronic device 101 or the housing 210, and a slide-in state of the display 203.

The state shown in FIG. 3 may be referred to as an open state of the electronic device 101 or the housing 210, and a slide-out state of the display 203.

Referring to FIGS. 2 and 3, the electronic device 101 may include a housing 210. The housing 210 may include a first housing 201 and a second housing 202 that is disposed to be movable relative to the first housing 201. In a certain embodiment of the disclosure, it may be interpreted that the electronic device has a structure in which the first housing 201 is disposed to be slidable relative to the second housing 202. According to an embodiment of the disclosure, the second housing 202 may be disposed to reciprocate a predetermined distance in the direction illustrated with respect to the first housing 201, for example, in the direction indicated by arrow (1).

According to an embodiment of the disclosure, the second housing 202 may be referred to as a slide part or a slide housing, and may be movable relative to the first housing 201. According to an embodiment of the disclosure, the second housing 202 may accommodate various electrical and electronic components, such as a circuit board or a battery.

According to an embodiment of the disclosure, the first housing 201 may have a motor, a speaker, a SIM socket, and/or a sub-circuit board electrically connected to a main circuit board, which are provided therein. The second housing 202 may accommodate a main circuit board having electrical components, such as an application processor (AP) or a communication processor (CP) mounted thereon.

According to an embodiment of the disclosure, the first housing 201 may include a first cover member 211 (e.g., a main case). The first cover member 211 may include a 1-1st side wall 211a, a 1-2nd side wall 211b extending from the 1-1st side wall 211a, and a 1-3rd side wall 211c extended from the 1-1st side wall 211a and substantially parallel to the 1-2nd side wall 211b. In an embodiment of the disclosure, the 1-2nd side wall 211b and the 1-3rd side wall 211c may be formed substantially perpendicular to the 1-1st side wall 211a.

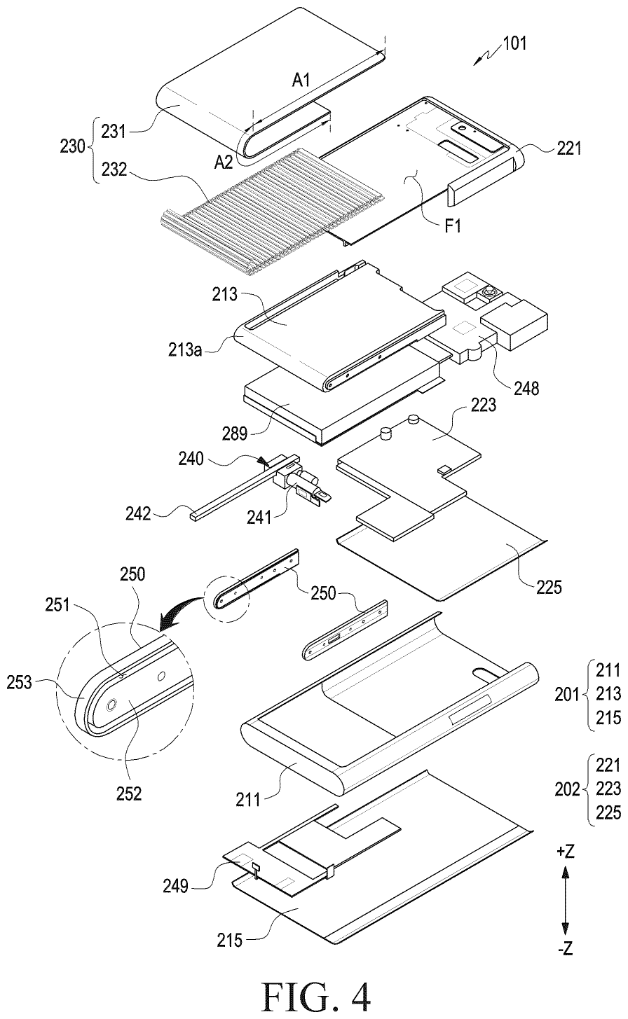

According to an embodiment of the disclosure, the 1-1st side wall 211a, the 1-2nd side wall 211b, and the 1-3rd side wall 211c of the first cover member 211 may be formed in a shape in which one side (e.g., a front face) is open to accommodate (or surround) at least a portion of the second housing 202. For example, at least a portion of the second housing 202 may be surrounded by the first housing 201 and may slide in a direction parallel to a first surface (e.g., the first surface F1 in FIG. 4), for example, in the direction of arrow (1), while being guided by the first housing 201. According to an embodiment of the disclosure, the 1-1st side wall 211a, the 1-2nd side wall 211b, and/or the 1-3rd side wall 211c of the first cover member 211 may be formed integrally. According to an embodiment of the disclosure, the 1-1st side wall 211a, the 1-2nd side wall 211b, and/or the 1-3rd side wall 211c of the first cover member 211 may be formed as separate structures and be coupled or assembled to each other.

According to an embodiment of the disclosure, the first cover member 211 may be formed to surround at least a portion of the display 203. For example, at least a portion of the display 203 may be formed to be surrounded by the 1-1st side wall 211a, the 1-2nd side wall 211b, and/or the 1-3rd side wall 211c of the first cover member 211.

According to an embodiment of the disclosure, the second housing 202 may include a second cover member 221 (e.g., a slide plate). The second cover member 221 may have a plate shape and include a first surface (e.g., the first surface F1 in FIG. 4) that supports internal components. For example, the second cover member 221 may support at least a portion (e.g., a first display area A1) of the display 203. According to an embodiment of the disclosure, the second cover member 221 may be referred to as a front cover.

According to an embodiment of the disclosure, the second cover member 221 may include a 2-1st side wall 221a, a 2-2nd side wall 221b extending from the 2-1st side wall 221a, and a 2-3rd side wall 221c extending from the 2-1st side wall 221a and substantially parallel to the 2-2nd side wall 221b. According to an embodiment of the disclosure, the 2-2nd side wall 221b and the 2-3rd side wall 221c may be formed substantially perpendicular to the 2-1st side wall 221a.

According to an embodiment of the disclosure, the second housing 202 may move in a first direction (e.g., the direction (1)) parallel to the 1-2nd side wall 211b or the 1-3rd side wall 211c, thereby switching between an open state and a closed state of the housing 210. In the closed state, the second housing 202 is positioned at a first distance from the 1-1st side wall 211a, and in the open state, the second housing 202 may move to be positioned at a second distance greater than the first distance from the 1-1 st side wall 211a. In a certain embodiment of the disclosure, in the closed state, the first housing 201 may surround a portion of the 2-1st side wall 221a.

According to an embodiment of the disclosure, the electronic device 101 may include a display 203, a key input device 245, a connector hole 243, audio modules 247a and 247b, or camera modules 249a and 249b. According to an embodiment of the disclosure, the electronic device 101 may further include an indicator (e.g., a light emitting diode (LED) device) or various sensor modules.

According to an embodiment of the disclosure, the display 203 may include a first display area A1 that is constantly exposed and a second display area A2 that is configured to be exposed to the outside of the electronic device 101, based on the sliding movement of the second housing 202. According to an embodiment of the disclosure, the first display area A1 may be disposed on the second housing 202. For example, the first display area A1 may be disposed on the second cover member 221 of the second housing 202. According to an embodiment of the disclosure, the second display area A2 may extend from the first display area A1, and may be received inside the first housing 201 (e.g., in a slide-in state) or visually exposed to the outside of the electronic device 101 (e.g., in a slide-out state) as the second housing 202 slides relative to the first housing 201.

According to an embodiment of the disclosure, the second display area A2 may move while substantially being guided by an area (e.g., the curved surface 213a in FIG. 4) of the first housing 201 so as to be received in an inner space of the first housing 201 or exposed to the outside of the electronic device 101. According to an embodiment of the disclosure, the second display area A2 may move based on the sliding movement of the second housing 202 in the first direction (e.g., the direction indicated by arrow (1). For example, while the second housing 202 is sliding, a portion of the second display area A2 may be transformed into a curved shape at a position corresponding to the curved surface 213a of the first housing 201.

In an embodiment of the disclosure, when viewed from above of the second cover member 221 (e.g., the front cover), if the housing 210 switches from the closed state to the open state (e.g., if the second housing 202 slides relative to the first housing 201 to expand), the second display area A2 may be gradually exposed to the outside of the first housing 201 to form a substantially flat surface together with the first display area A1. In an embodiment of the disclosure, the display 203 may be connected to or disposed adjacent to a touch detection circuit, a pressure sensor capable of measuring the intensity (pressure) of a touch, and/or a digitizer capable of detecting a magnetic field-type stylus pen. According to an embodiment of the disclosure, regardless of the closed or open state of the housing 210, a portion of the exposed second display area A2 may be positioned on a portion of the first housing (e.g., the curved surface 213a in FIG. 4), and a portion of the second display area A2 may maintain a curved shape at a position corresponding to the curved surface 213a.

According to an embodiment of the disclosure, the key input device 245 may be positioned in one area of the first housing 201. Depending on the appearance and the usage state, the electronic device 101 may be designed to exclude the illustrated key input device 245 or include additional key input devices. According to an embodiment of the disclosure, the electronic device 101 may include a key input device not illustrated, for example, a home key button, or a touch pad disposed around the home key button. According to an embodiment of the disclosure, at least a part of the key input device 245 may be positioned on the 1-1st side wall 211a, the 1-2nd side wall 211b, and/or the 1-3rd side wall 211c of the first housing 201. According to an embodiment of the disclosure, at least a part of the key input device 245 may be positioned on the second housing 202.

According to an embodiment of the disclosure, the connector hole 243 may be omitted depending on the embodiment of the disclosure, and may accommodate a connector (e.g., a USB connector) for transmitting and receiving power and/or data to and from an external electronic device. According to an embodiment (not shown) of the disclosure, the electronic device 101 may include a plurality of connector holes 243, and some of the plurality of connector holes 243 may function as connector holes for transmitting and receiving audio signals to and from an external electronic device. In the illustrated embodiment of the disclosure, although the connector hole 243 is located in the second housing 202, it is not limited thereto, and the connector hole 243 or a connector hole not illustrated may be located in the first housing 201.

According to an embodiment of the disclosure, the audio modules 247a and 247b may include at least one speaker hole 247a or at least one microphone hole 247b. One of the speaker holes 247a may be provided as a receiver hole for voice calls, and another may be provided as an external speaker hole. The electronic device 101 may include a microphone for acquiring sound, and the microphone may acquire sound from outside the electronic device 101 through the microphone hole 247b. According to an embodiment of the disclosure, the electronic device 101 may include a plurality of microphones to detect the direction of sound. According to an embodiment of the disclosure, the electronic device 101 may include an audio module in which a speaker hole 247a and a microphone hole 247b are implemented as a single hole, or may include a speaker (e.g., a piezo speaker) from which the speaker hole 247a is excluded.

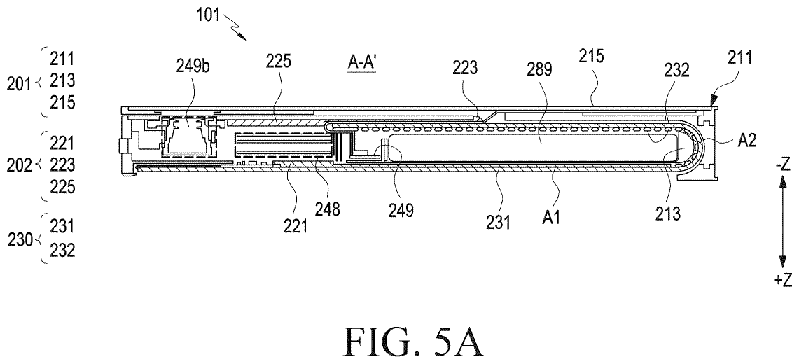

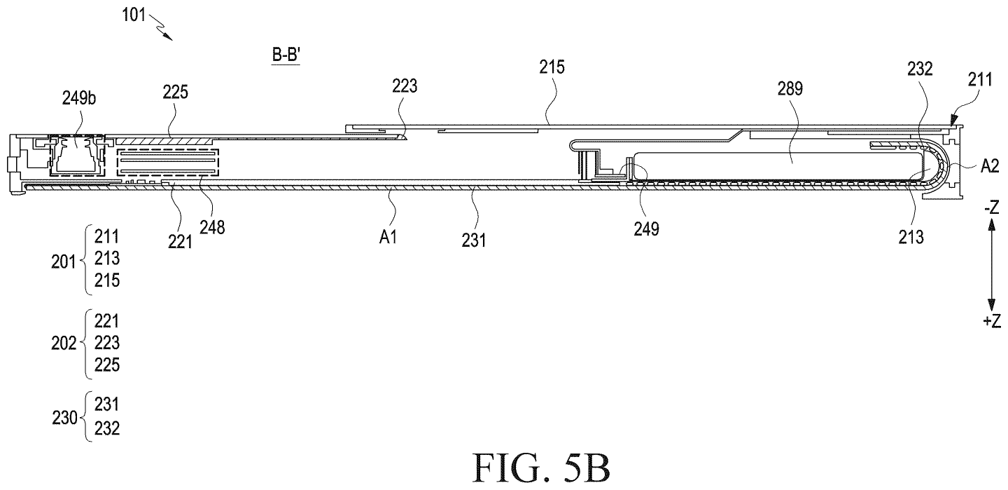

According to an embodiment of the disclosure, the camera modules 249a and 249b may include a first camera module 249a (e.g., a front camera) and a second camera module 249b (e.g., a rear camera) (e.g., the second camera module 249b in FIGS. 5A and 5B). According to an embodiment of the disclosure, the electronic device 101 may include at least one of a wide-angle camera, a telephoto camera, or a close-up camera, and may measure a distance to a subject by including an infrared projector and/or an infrared receiver according to an embodiment. The camera modules 249a and 249b may include one or more lenses, an image sensor, and/or an image signal processor. The first camera module 249a may be disposed to face in the same direction as the display 203. For example, the first camera module 249a may be disposed around the first display area A1 or in an area overlapping the display 203, and in the case where the first camera module 249a disposed in the area overlapping the display 203, it may capture a subject through the display 203. According to an embodiment of the disclosure, the first camera module 249a may include an under-display camera (UDC) that is hidden, instead of being visually exposed to the screen display area (e.g., the first display area A1). According to an embodiment of the disclosure, the second camera module 249b may capture a subject from a direction opposite the first display area A1. According to an embodiment of the disclosure, the first camera module 249a and/or the second camera module 249b may be disposed on the second housing 202.

According to an embodiment of the disclosure, an indicator (not shown) of the electronic device 101 may be disposed in the first housing 201 or the second housing 202, and may include a light-emitting diode to provide status information of the electronic device 101 as a visual signal. A sensor module (not shown) of the electronic device 101 may generate an electric signal or data value corresponding to an internal operating state of the electronic device 101 or an external environmental state. The sensor module may include, for example, a proximity sensor, a fingerprint sensor, or a biometric sensor (e.g., an iris/facial recognition sensor or an HRM sensor). In another embodiment of the disclosure, the sensor module may further include at least one of, for example, a gesture sensor, a gyro sensor, a barometric pressure sensor, a magnetic sensor, an acceleration sensor, a grip sensor, a color sensor, an infrared (IR) sensor, a temperature sensor, a humidity sensor, or an illuminance sensor.

FIG. 4 is an exploded perspective view of an electronic device according to an embodiment of the disclosure. FIG. 5A is a cross-sectional view taken along line A-A′ in FIG. 2 according to an embodiment of the disclosure. FIG. 5B is a cross-sectional view taken along line B-B′ in FIG. 3 according to an embodiment of the disclosure.

Referring to FIG. 4, FIG. 5A, and/or FIG. 5B, the electronic device 101 may include a first housing 201, a second housing 202, a display assembly 230, and a driving structure 240. All or some of the configurations of the first housing 201, the second housing 202, and the display assembly 230 in FIG. 4, FIG. 5A, and/or FIG. 5B may be the same as the those of the first housing 201, the second housing 202, and the display 203 in FIG. 2 and/or FIG. 3.

According to an embodiment of the disclosure, the first housing 201 may include a first cover member 211 (e.g., the first cover member 211 in FIGS. 2 and 3), a frame 213, and a first rear plate 215.

In an embodiment of the disclosure, the first cover member 211 may accommodate at least a portion of the frame 213 and accommodate components (e.g., a battery 289) positioned on the frame 213. In an embodiment of the disclosure, the first cover member 211 may be formed to surround at least a portion of the second housing 202. According to an embodiment of the disclosure, a second circuit board 249 that accommodates electronic components (e.g., the processor 120 and/or the memory 130 in FIG. 1) may be connected to the first cover member 211.

According to an embodiment of the disclosure, the frame 213 may be connected to the first cover member 211. For example, the frame 213 may be connected to the first cover member 211, and the second housing 202 may move relative to the first cover member 211 and/or the frame 213. According to an embodiment of the disclosure, the frame 213 may accommodate a battery 289. According to an embodiment of the disclosure, the frame 213 may include a curved surface 213a that faces the display assembly 230.

According to an embodiment of the disclosure, the first rear plate 215 may substantially constitute at least a part of the exterior of the first housing 201 or the electronic device 101. For example, the first rear plate 215 may be coupled to an outer surface of the first cover member 221. According to an embodiment of the disclosure, the first rear plate 215 may provide a decorative effect to the exterior of the electronic device 101. The first rear plate 215 may be manufactured using at least one of metal, glass, synthetic resin, or ceramic.

According to an embodiment of the disclosure, the second housing 202 may include a second cover member 221 (e.g., the second cover member 221 in FIGS. 2 and 3), a rear cover 223, and a second rear plate 225.

According to an embodiment of the disclosure, the second cover member 221 may be connected to the first housing 201 through a guide rail 250, and may reciprocate linearly in one direction (e.g., in the direction of arrow (1) in FIG. 3) while being guided by the guide rail 250.

According to an embodiment of the disclosure, the second cover member 221 may support at least a portion of the display 203. For example, the second cover member 221 may include a first surface F1, and the first display area A1 of the display 203 may be substantially positioned on the first surface F1 and maintained in a flat form. According to an embodiment of the disclosure, the second cover member 221 may be formed of a metal material and/or a non-metal material (e.g., polymer). According to an embodiment of the disclosure, a first circuit board 248 that accommodates electronic components (e.g., the processor 120 and/or the memory 130 in FIG. 1) may be connected to the second cover member 221.

According to an embodiment of the disclosure, the rear cover 223 may protect components (e.g., the first circuit board 248) positioned on the second cover member 221. For example, the rear cover 223 may be connected to the second cover member 221 and formed to surround at least a portion of the first circuit board 248. According to an embodiment of the disclosure, the rear cover 223 may include an antenna pattern for communication with an external electronic device. For example, the rear cover 223 may include a laser direct structuring (LDS) antenna.

According to an embodiment of the disclosure, the second rear plate 225 may substantially form at least a portion of the exterior of the second housing 202 or the electronic device 101. For example, the second rear plate 225 may be coupled to an outer surface of the second cover member 221. According to an embodiment of the disclosure, the second rear plate 225 may provide a decorative effect to the exterior of the electronic device 101. The second rear plate 225 may be manufactured using at least one of metal, glass, synthetic resin, or ceramic.

According to an embodiment of the disclosure, the display assembly 230 may include a display 231 (e.g., the display 203 in FIG. 2 and/or FIG. 3) and a multi-bar structure 232 supporting the display 231. According to an embodiment of the disclosure, the display 231 may be referred to as a flexible display, a foldable display, and/or a rollable display.

According to an embodiment of the disclosure, the multi-bar structure 232 may be connected or attached to at least a portion (e.g., the second display area A2) of the display 231. According to an embodiment of the disclosure, as the second housing 202 slides, the multi-bar structure 232 may move relative to the first housing 201. In the closed state of the electronic device 101 (e.g., FIG. 2), the multi-bar structure 232 may be mostly accommodated inside the first housing 201 and positioned between the first cover member 211 and the second cover member 221. According to an embodiment of the disclosure, at least a portion of the multi-bar structure 232 may move to correspond to the curved surface 213a located at the edge of the frame 213. According to an embodiment of the disclosure, the multi-bar structure 232 may be referred to as a display support member or support structure, and may be in the form of a single elastic plate.

According to an embodiment of the disclosure, the driving structure 240 may move the second housing 202 relative to the first housing 201. For example, the driving structure 240 may include a motor 241 configured to generate a driving force for sliding movement of the first housing 201 and the second housing 202. The driving structure 240 may include a gear (e.g., a pinion) connected to a motor 241 and a rack 242 configured to engage with the gear.

According to an embodiment of the disclosure, the housing in which the rack 242 is located and the housing in which the motor 241 is located may be different. According to an embodiment of the disclosure, the motor 241 may be connected to the second housing 202, and the rack 242 may be connected to the first housing 201. In another embodiment of the disclosure, the motor 241 may be connected to the first housing 201, and the rack 242 may be connected to the second housing 202.

According to an embodiment of the disclosure, the first housing 201 may accommodate a first circuit board 248 (e.g., a main board). According to an embodiment of the disclosure, a processor, memory, and/or an interface may be mounted on the first circuit board 248. The processor may include, for example, one or more of a central processing unit, an application processor, a graphics processing unit, an image signal processor, a sensor hub processor, or a communications processor. According to an embodiment of the disclosure, the first circuit board 248 may include a flexible printed circuit board-type radio frequency cable (FRC). The first circuit board 248 may be disposed on at least a portion of the second cover member 221 and may be electrically connected to an antenna module and a communication module.

According to an embodiment of the disclosure, the memory may include, for example, volatile memory or nonvolatile memory.

According to an embodiment of the disclosure, the interface may include, for example, a high-definition multimedia interface (HDMI), a universal serial bus (USB) interface, an SD card interface, and/or an audio interface. The interface may electrically or physically connect the electronic device 101 to an external electronic device, and may include, for example, a USB connector, an SD card/multimedia card (MMC) connector, or an audio connector.

According to an embodiment of the disclosure, the electronic device 101 may include a second circuit board 249 (e.g., a sub-circuit board) spaced apart from the first circuit board 248 (e.g., a main circuit board) inside the first housing 201. The second circuit board 249 may be electrically connected to the first circuit board 248 through a connecting flexible board. The second circuit board 249 may be electrically connected to electrical components disposed in an end area of the electronic device 101, such as a battery 289, a speaker, and/or a SIM socket, to transmit signals and power. According to an embodiment of the disclosure, the second circuit board 249 may accommodate a wireless charging antenna (e.g., a coil). For example, the battery 289 may receive power from an external electronic device using the wireless charging antenna. In another example, the battery 289 may transmit power to an external electronic device using the wireless charging antenna.

According to an embodiment of the disclosure, the battery 289 is a device for supplying power to at least one component of the electronic device 101, and may include a non-rechargeable primary battery, a rechargeable secondary battery, or a fuel cell. The battery 289 may be integrally disposed inside the electronic device 101, and may be disposed to be detachable from the electronic device 101. According to an embodiment of the disclosure, the battery 289 may be formed as a single integral battery or may include multiple detachable batteries. According to an embodiment of the disclosure, the battery 289 may be positioned in the frame 213, and the battery 289 may slide together with the frame 213.

According to an embodiment of the disclosure, the guide rail 250 may guide the movement of the multi-bar structure 232. For example, the multi-bar structure 232 may slide along a slit 251 formed in the guide rail 250. According to an embodiment of the disclosure, the guide rail 250 may be connected to the first housing 201. For example, the guide rail 250 may be connected to the first cover member 211 and/or the frame 213. According to an embodiment of the disclosure, the slit 251 may be referred to as a groove or recess formed on the inner surface of the guide rail 250.

According to an embodiment of the disclosure, the guide rail 250 may provide pressure to the multi-bar structure 233, based on the driving of the motor 241.

According to an embodiment of the disclosure, when the electronic device 101 switches from the closed state to the open state, an inner portion 252 of the guide rail 250 may provide pressure to the multi-bar structure 232. The multi-bar structure 232 provided with the pressure may move along the slit 251 of the guide rail 250, and the second housing 202 may switch from the slide-in state to the slide-out state with respect to the first housing 201. At least a portion of the display assembly 230 accommodated between the first cover member 211 and the frame 213 may expand toward the front.

According to an embodiment of the disclosure, when the electronic device 101 switches from the open state to the closed state, an outer portion 253 of the guide rail 250 may provide pressure to the bent multi-bar structure 232. The multi-bar structure 232 provided with the pressure may move along the slit 251 of the guide rail 250, and the second housing 202 may switch from the slide-out state to the slide-in state with respect to the first housing 201. At least a portion of the display assembly 230 may be received between the first cover member 211 and the frame 213.

Referring to FIG. 5A, when the electronic device 101 is in the closed state, at least a portion of the second housing 202 may be disposed to be received in the first housing 201. As the second housing 202 is disposed to be received in the first housing 201, the overall volume of the electronic device 101 may be reduced. According to an embodiment of the disclosure, when the second housing 202 is received in the first housing 201, the size of the visually exposed display 231 may be minimized. For example, when the second housing 202 is completely received inside the first housing 201, the first display area A1 of the display 231 may be visually exposed, and the second display area A2 may not be visually exposed. At least a portion of the second display area A2 may be disposed between the battery 289 and the first rear plate 215 or the second rear plate 225.

Referring to FIG. 5B, when the electronic device 101 is in the open state, at least a portion of the second housing 202 may protrude from the first housing 201. As the second housing 202 protrudes from the first housing 201, the overall volume of the electronic device 101 may increase. According to an embodiment of the disclosure, when the second housing 202 protrudes from the first housing 201, at least a portion of the second display area A2 of the display 231 may be visually exposed to the outside of the electronic device 101 together with the first display area A1.

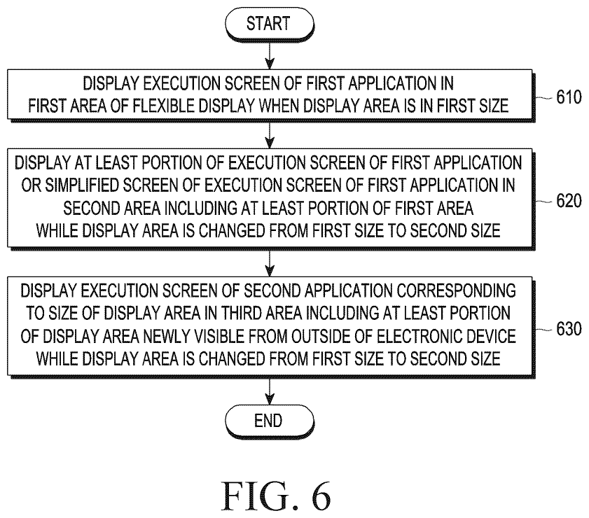

FIG. 6 is a flowchart illustrating an operation in which an electronic device executes a multi-window function while a display area of a flexible display is changed according to an embodiment of the disclosure.

Referring to FIG. 6, in operation 610, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may display an execution screen of a first application in a first area of a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) in the state where the display area is in a first size.

According to an embodiment of the disclosure, based on movement of at least a part of the housing (e.g., the first housing 201 in FIG. 2 or the second housing 202 in FIG. 2), the size of the display area of the flexible display, which is visible from the outside of the electronic device, may be variable from a first size to a second size. For example, the first size may be the minimum size of the display area of the flexible display, and the second size may be the maximum size of the display area of the flexible display.

According to an embodiment of the disclosure, a status bar indicating the status of the electronic device (e.g., carrier information, clock information, battery level, network connection information, notification information, communication status, or notification) may be included in the top of the display area.

According to an embodiment of the disclosure, a control bar (e.g., a navigation bar) including at least one UI (e.g., a recently used application confirmation key, a home key, or a back key) for controlling the electronic device may be included at the bottom of the display area.

According to an embodiment of the disclosure, the electronic device may display a first application execution screen in a first area, excluding a status bar and/or a control bar of, a display area having a first size.

According to an embodiment of the disclosure, in operation 620, the electronic device may display at least a portion of the execution screen of the first application or a simplified screen of the execution screen of the first application in a second area including at least a portion of the first area while the display area is changing from the first size to the second size.

According to an embodiment of the disclosure, the electronic device may change the display area from the first size to the second size, based on receiving a user input for adjusting the size of the display area and executing a multi-window function in the state where the display area is in the first size.

According to an embodiment of the disclosure, the user input for adjusting the size of the display area and executing a multi-window function (e.g., pressing a physical key twice for adjusting the size of the display area) may be different from a user input for adjusting the size of the display area (e.g., pressing a physical key once for adjusting the size of the display area).

According to an embodiment of the disclosure, in the case where the electronic device adjusts the size of the display area from the first size to the second size, based on the reception of a user input for adjusting the size of the display area, the electronic device may display the lower portion of the execution screen of the first application, which was not visible in the first size, in the display area of the second size.

According to an embodiment of the disclosure, the electronic device, based on the reception of the user input for adjusting the size of the display area and executing a multi-window function, may increase the size of the display area and divide the display area into two areas, thereby executing the multi-window function. For example, operation 620 and operation 630 described below may be performed simultaneously while the size of the display area is changed from the first size to the second size.

According to an embodiment of the disclosure, in operation 630, the electronic device may display an execution screen of a second application, corresponding to the size of the display area, in a third area including at least a portion of the display area (e.g., the second display area A2 in FIG. 3) newly visible from the outside of the electronic device while the display area is changed from the first size to the second size.

According to an embodiment of the disclosure, the third area may be disposed below the second area (e.g., in the −Y-axis direction). For example, if the flexible display moves upward (e.g., in the +Y-axis direction) so that the size of the display area increases, or if the flexible display moves downward so that the size of the display area is reduced, the second area may be disposed at the top of the display area, and the third area may be disposed at the bottom of the display area.

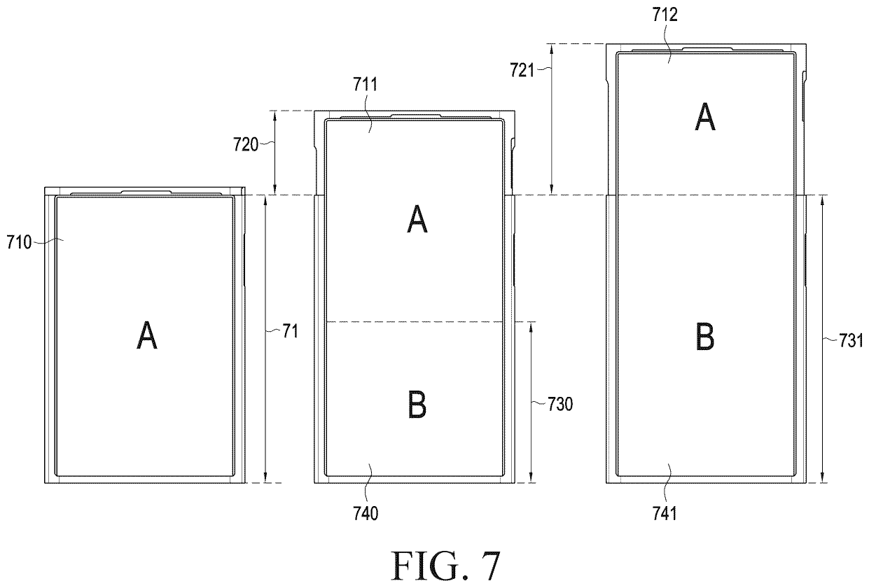

According to an embodiment of the disclosure, if the size of the display area changes based on the movement of the flexible display, the changes of the second area and the third area will be described with reference to FIG. 7 below.

According to an embodiment of the disclosure, the third area may be disposed at the left side of the second area. For example, if the flexible display moves to the right so that the size of the display area increases, or if the flexible display moves to the left so that the size of the display area decreases, the second area may be disposed at the right side of the display area, and the third area may be disposed at the left side of the display area.

According to an embodiment of the disclosure, the third area may be positioned at the right side of the second area. For example, if the flexible display moves to the left so that the size of the display area increases, or if the flexible display moves to the right so that the size of the display area decreases, the second area may be positioned at the left side of the display area, and the third area may be positioned at the right side of the display area. Although the disclosure describes an embodiment in which the flexible display moves upward (in the +Y direction), the disclosure may also be applied to the case in which the flexible display moves to the left or to the right.

According to an embodiment of the disclosure, as illustrated in FIG. 7, the electronic device may reduce the size of the second area related to the execution screen of the first application and increase the size of the third area that includes at least a portion of the display area newly visible from the outside and is related to the execution screen of the second application while the display area is changed from the first size to the second size. According to an embodiment of the disclosure, the electronic device may reduce the size of the second area where the execution screen of the second application is displayed while the size of the third area where the execution screen of the second application is displayed is increased. According to an embodiment of the disclosure, the electronic device may reduce the ratio of the second area in the display area and increase the ratio of the remaining area, i.e., the third area while the size of the display area is increased based on the movement of the flexible display.

According to an embodiment of the disclosure, the velocity at which the execution screen of the second application is displayed corresponding the size of the display area may be different from the velocity at which the size of the display area of the flexible display is changed. According to an embodiment of the disclosure, the velocity may include speed and direction. According to an embodiment of the disclosure, at least one of the speed or direction in which the execution screen of the second application moves within the display area may be different from at least one of the speed or direction in which the size of the display area changes.

As described above, since the velocity at which the execution screen of the second application is displayed is different from the velocity at which the execution screen of the first application is displayed, different animation effects may be provided to the execution screen of the first application and the execution screen of the second application.

FIG. 7 is a diagram illustrating an area of a multi-window, based on a change in a display area of a flexible display of an electronic device, according to an embodiment of the disclosure.

Referring to FIG. 7, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may display an execution screen (e.g., A in FIG. 7) of a first application in a first area 710 of a display area of a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) that is visible from the outside in the state where the display area is in a first size. For example, the first area 710 may be the same as the display area, or may be an area excluding the status bar at the top and/or the control bar at the bottom of the display area.

According to an embodiment of the disclosure, if a user input for adjusting (e.g., increasing) the size of the display area and executing a multi-window function is received when the size of the display area is the first size, the electronic device may move the flexible display upward (e.g., in the +Y-axis direction).

According to an embodiment of the disclosure, as the flexible display moves upward, the electronic device may reduce the size of the second area 711 that includes at least a portion of the first area 710 and is related to the execution screen of the first application (e.g., A in FIG. 7). According to an embodiment of the disclosure, the reduction in the size of the second area 711 may indicate that the vertical length of the second area 711 (e.g., in the Y-axis direction) is reduced. According to an embodiment of the disclosure, based on the reduction in the size of the second area 711, at least a portion of the execution screen of the first application or a simplified screen of the execution screen of the first application may be displayed in the second area 711. According to an embodiment of the disclosure, the simplified screen may include a screen obtained by changing an image included in the execution screen of the first application, based on the second area, or a screen obtained by changing a preview screen, based on the second area.

For example, if the flexible display moves upward by the first length 720, the bottom of the second area 711 where the execution screen of the first application is displayed may be reduced by the first length 720.

According to an embodiment of the disclosure, as the flexible display of the electronic device moves upward, a new display area may become visible at the bottom of the electronic device. According to an embodiment of the disclosure, the electronic device may display an execution screen of the second application (e.g., B in FIG. 7) in a third area 740 including at least a portion of the newly visible display area. According to an embodiment of the disclosure, the size of the third area 740 may increase as the flexible display moves upward. According to an embodiment of the disclosure, the increase in the size of the third area 740 may indicate that the vertical length of the third area 740 increases.

For example, if the flexible display moves upward by the first length 720, a vertical length 730 of the third area 740 where the execution screen of the second application (e.g., B in FIG. 7) is displayed may be the sum of a first length 720 and the vertical length of the newly visible display area.

According to an embodiment of the disclosure, based on the completion of the movement of the flexible display, the reduction of the second area 711 and the increase of the third area 740 may also be completed. For example, if the flexible display moves upward by a second length 721 and completes the movement, the vertical length of a second area 712 that has been reduced may be the same as the second length 721, and a vertical length 731 of a third area 741 that has been increased may be the same as a vertical length 71 of the display area before the movement. According to an embodiment of the disclosure, the ratio (e.g., 16:9) of the horizontal length and the vertical length of the second area 712 that has been reduced may be a reciprocal of the ratio (e.g., 9:16) of the horizontal length and the vertical length of the third area 741 that has been increased.

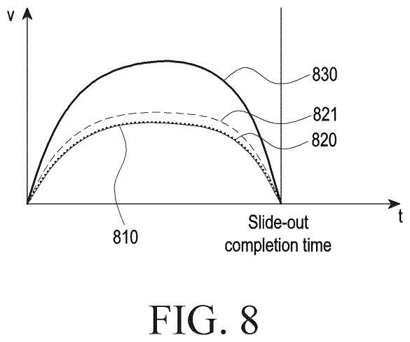

According to an embodiment of the disclosure, the electronic device may increase the size of the third area 740, based on moving the top of the third area upward from the bottom of the display area according to the movement of the flexible display. According to an embodiment of the disclosure, as illustrated in FIG. 8, the velocity at which the execution screen of the second application is displayed in the third area may be faster than the velocity at which the flexible display moves.

FIG. 8 is a diagram illustrating a change velocity of a display area of a flexible display and a movement velocity of each area of a multi-window in an electronic device according to an embodiment of the disclosure. For example, FIG. 8 illustrates the movement velocities of the flexible display, the execution screen of the first application, and the execution screen of the second application, which move in the same direction (e.g., the upward direction (+Y direction)).

Referring to FIG. 8, a movement velocity 810 of the flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) may gradually increase from 0 when the movement starts, remain at a constant velocity, and decrease before the movement is completed, so that the velocity becomes 0 when the movement is completed (e.g., in a slide-out state). According to an embodiment of the disclosure, the movement distance of the flexible display may be the area between the graph (y-axis or velocity (v)-axis) representing the movement velocity 810 and the x-axis (or time (t)-axis).

According to an embodiment of the disclosure, a movement velocity 820 of the execution screen of the first application displayed before the flexible display moves may be the same as the movement velocity 810 of the flexible display (or the velocity at which the size of the display area of the flexible display changes). For example, the case where the movement velocity 820 of the execution screen of the first application is the same as the movement velocity 810 of the flexible display may be the case where the topmost partial area of the execution screen of the first application moves along with the movement of the flexible display and is also displayed in the second area including at least a portion of the first area.

According to an embodiment of the disclosure, if a partial area, excluding the topmost area of the execution screen of the first application, is displayed in the second area, a movement velocity 821 of the execution screen of the first application may be higher than the movement velocity 810 of the flexible display. According to an embodiment of the disclosure, the movement distance of a partial area (the distance by which it is moved and displayed on the flexible display), excluding the topmost area of the execution screen of the first application, may be greater than the movement distance of the flexible display because it corresponds to the sum of the movement distance of the flexible display and the movement distance of the topmost area of the execution screen of the first application.

According to an embodiment of the disclosure, a movement velocity 830 of the execution screen of the second application, which is newly displayed from the bottom of the display area according to the movement of the flexible display, may be higher than the movement velocity 810 of the flexible display.

According to an embodiment of the disclosure, the movement velocity 830 of the top of the execution screen of the second application may be higher than the movement velocity 810 of the flexible display because it must move a longer distance from the bottom of the display area than the movement distance of the flexible display while the flexible display is moving.

According to an embodiment of the disclosure, the movement velocities 820, 821, and 830 of the execution screens of the applications and the movement velocity 810 of the flexible display may be the perceived velocities at which the content displayed on the flexible display moves by the user's eyes.

According to an embodiment of the disclosure, the movement distance of the top of the execution screen of the second application may be the area between the graph representing the movement velocity 830 and the x-axis.

According to an embodiment of the disclosure, referring to FIG. 8, based on the completion of the movement of the flexible display, both the movement of the execution screen of the first application and the movement of the execution screen of the second application may be identified to be completed.

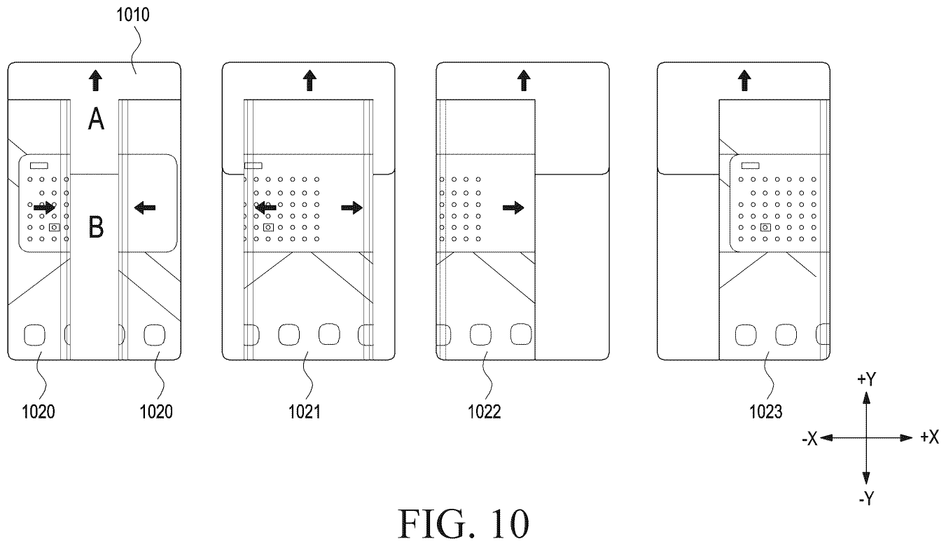

Referring back to FIG. 6, according to an embodiment of the disclosure, the direction in which the execution screen of the second application is displayed in the third area may be different from the direction in which the flexible display moves. According to an embodiment of the disclosure, the electronic device may increase the size of the third area, based on moving at least a portion of the third area from at least one of the left end or right end of the third area. According to an embodiment of the disclosure, an embodiment in which the direction in which the execution screen of the second application is displayed is different from the direction in which the flexible display moves will be described with reference to FIG. 10 below.

According to an embodiment of the disclosure, the electronic device may reduce the size of the second area in which the execution screen of the first application is displayed while increasing the size of the third area in which the execution screen of the second application is displayed. According to an embodiment of the disclosure, the electronic device may make a partial area of the execution screen of the first application gradually disappear while reducing the size of the second area.

According to an embodiment of the disclosure, when a user input for adjusting the size of the flexible display and executing a multi-window function is received, the electronic device may determine a partial area to be displayed in the second area that has completed moving from the execution screen of the first application displayed. For example, the electronic device may determine the topmost area of the execution screen of the first application corresponding to the size of the second area that has completed moving as a partial area to be displayed in the second area that has completed moving. According to an embodiment of the disclosure, the electronic device may determine an image or a preview screen included in the execution screen of the first application as a partial area to be displayed in the second area that has completed moving.

According to an embodiment of the disclosure, the electronic device may cause the area of the execution screen of the first application, excluding the partial area to be displayed in the second area that has completed moving, to gradually darken or blur and disappear while the flexible display is moving.

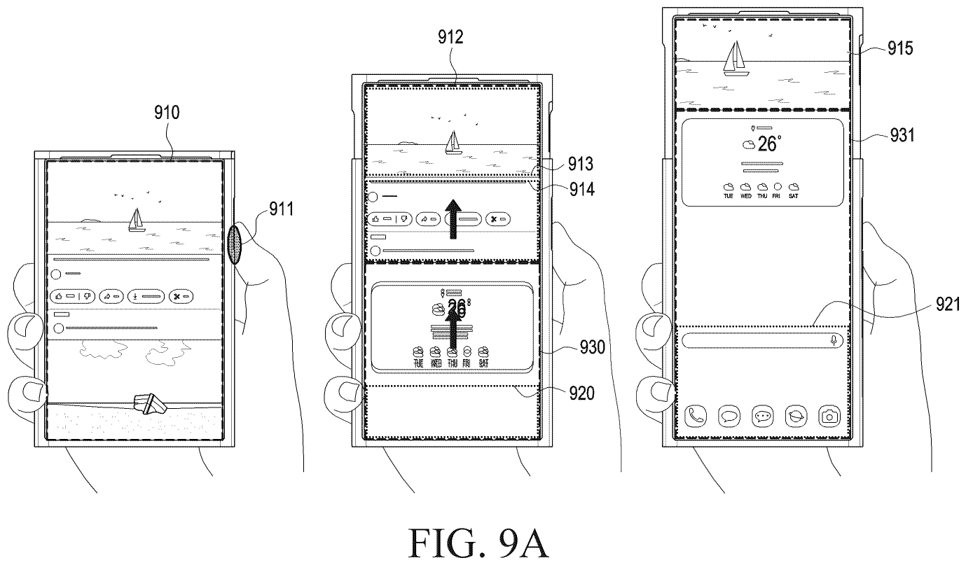

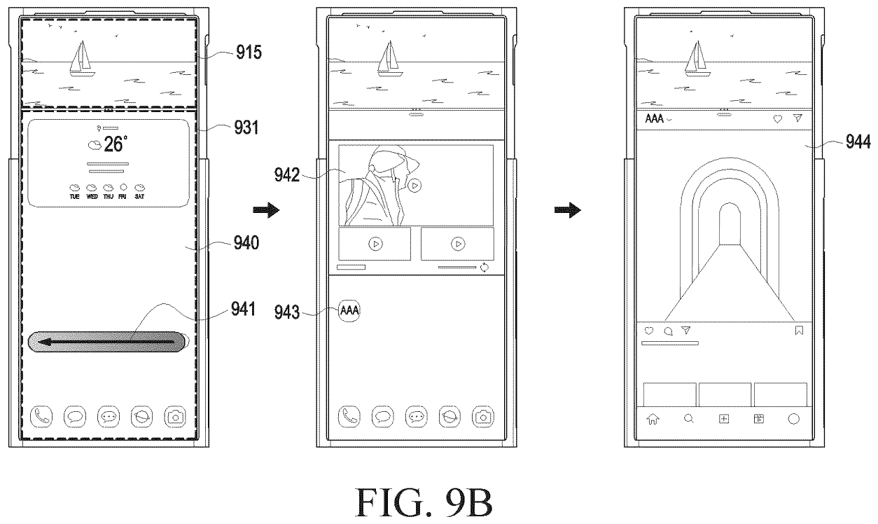

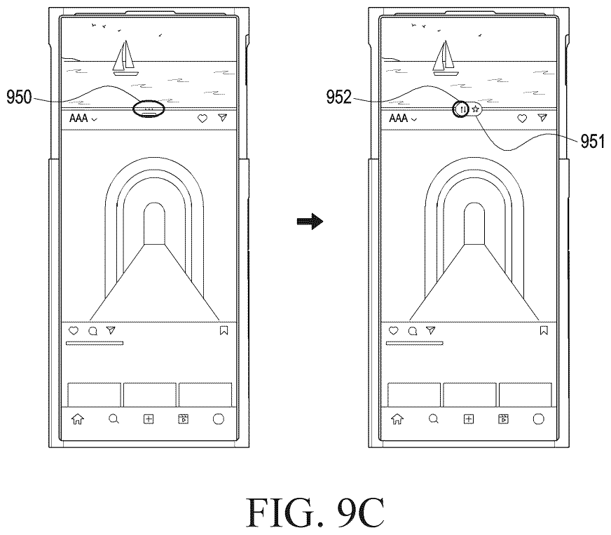

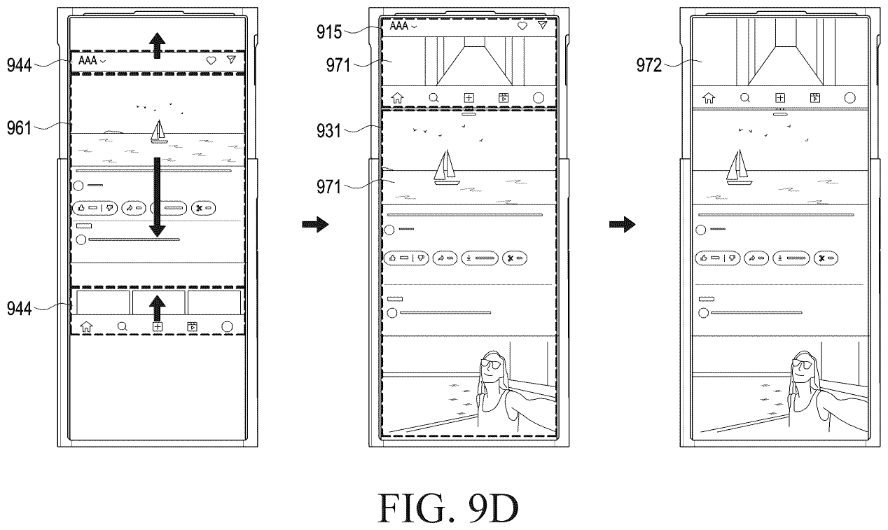

According to an embodiment of the disclosure, an operation in which a partial area of the execution screen of the first application gradually disappears while the size of the second area is reduced will be described with reference to FIG. 9A below.

According to an embodiment of the disclosure, if the size of an image or preview screen included in the execution screen of the first application is greater than the size of the second area that has completed moving, the electronic device may gradually reduce and change the size of the image or preview screen included in the execution screen of the first application to the size of the second area that has completed moving while the flexible display is moving.

According to an embodiment of the disclosure, based on the completion of the reduction in the size of the second area, the remaining area, excluding the partial area, of the execution screen of the first application or a simplified screen may be displayed. According to an embodiment of the disclosure, the simplified screen may be a screen obtained by changing an image included in the execution screen of the first application, based on the second area that has completed moving, or a screen obtained by changing a preview screen, based on the second area that has completed moving.

According to an embodiment of the disclosure, the electronic device may display a partial area of the execution screen of the second application to overlap a partial area of the execution screen of the first application while the size of the third area, where the execution screen of the second application is displayed, is increasing. According to an embodiment of the disclosure, an embodiment in which a partial area of the execution screen of the second application overlaps a partial area of the execution screen of the first application while the size of the third area is increasing based on the movement of the flexible display will be described with reference to FIG. 10 below.

According to an embodiment of the disclosure, the electronic device may display a boundary between the second area and the third area, based on the completion of the increase in the size of the third area in which the execution screen of the second application is displayed.

According to an embodiment of the disclosure, the electronic device may display at least one UI for controlling at least one of the execution screen of the first application or the execution screen of the second application in a partial area of the boundary. According to an embodiment of the disclosure, the at least one UI may include at least one of a UI for switching the positions of the execution screen of the first application and the execution screen of the second application, a UI for changing the second execution screen of the second application to a home screen, or a UI for changing the execution screen of the second application to an execution screen of a recently used application. According to an embodiment of the disclosure, the operation of displaying a UI for controlling the execution screen on the boundary between the second area and the third area will be described with reference to FIG. 9C below.

According to an embodiment of the disclosure, in the state in which the size of the third area where the execution screen of the second application is displayed is completely increased, the ratio of the horizontal length and the vertical length of the second area may be a reciprocal of the ratio of the horizontal length and the vertical length of the third area.

According to an embodiment of the disclosure, the execution screen of the second application displayed in the third area may be a home screen.

According to an embodiment of the disclosure, the execution screen of the second application displayed in the third area may be an application related to the first application displayed in the second area.

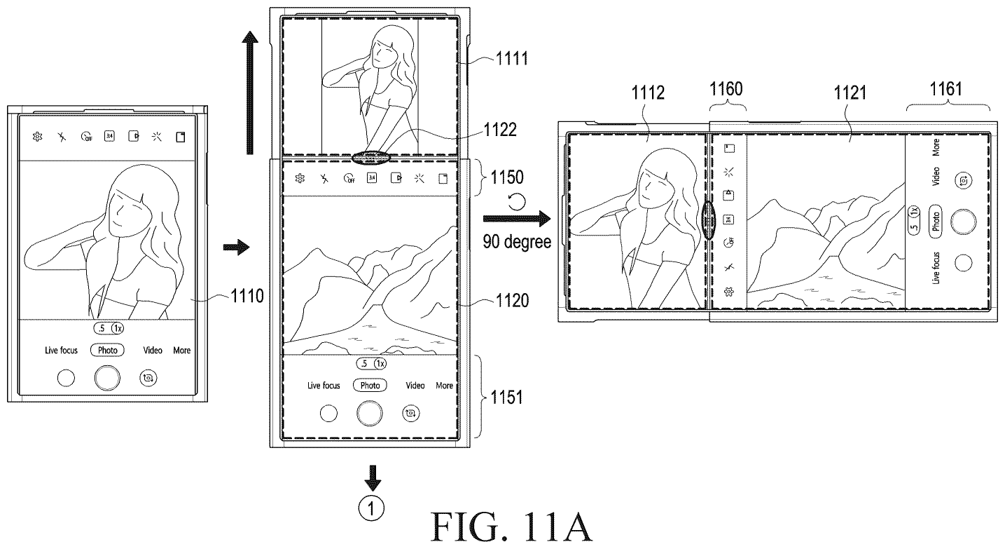

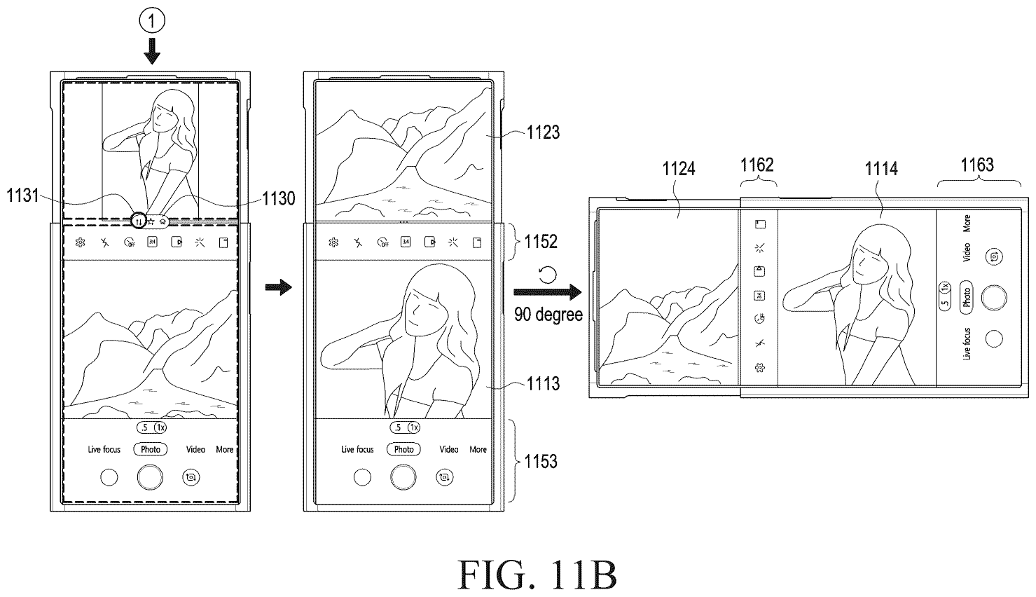

For example, based on the execution screen of the first application that is the execution screen of the front camera or the execution screen of the rear camera, the electronic device may display a preview screen of the execution screen of the front camera or the execution screen of the rear camera in the second area. According to an embodiment of the disclosure, the electronic device may display the remaining one of the execution screen of the front camera and the execution screen of the rear camera, as the execution screen of the second application, in the third area. According to an embodiment of the disclosure, an operation of the electronic device when a user input for adjusting the size of the display area and executing a multi-window is received while displaying the execution screen of the front camera or rear camera in the first area in the state in which the display area is in the first size will be described with reference to FIGS. 11A and 11B below.

According to an embodiment of the disclosure, the electronic device may display a notification message when a notification event occurs (e.g., a message is received) while the execution screen of the first application is being displayed in the first area. For example, the notification message may be displayed as a pop-up screen for a configured time.

According to an embodiment of the disclosure, the electronic device may change the display area from the first size to the second size, based on receiving a user input for adjusting the size of the display area and executing a multi-window while the notification message is being displayed.

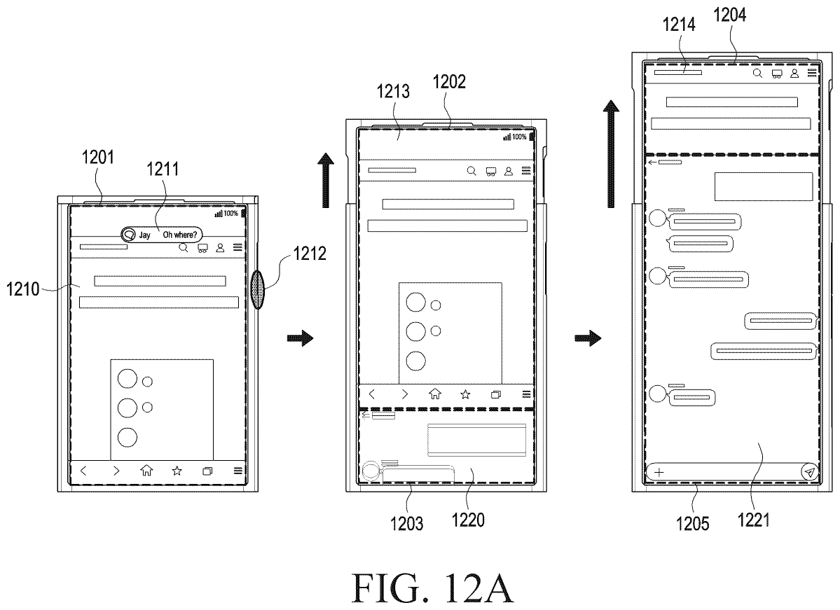

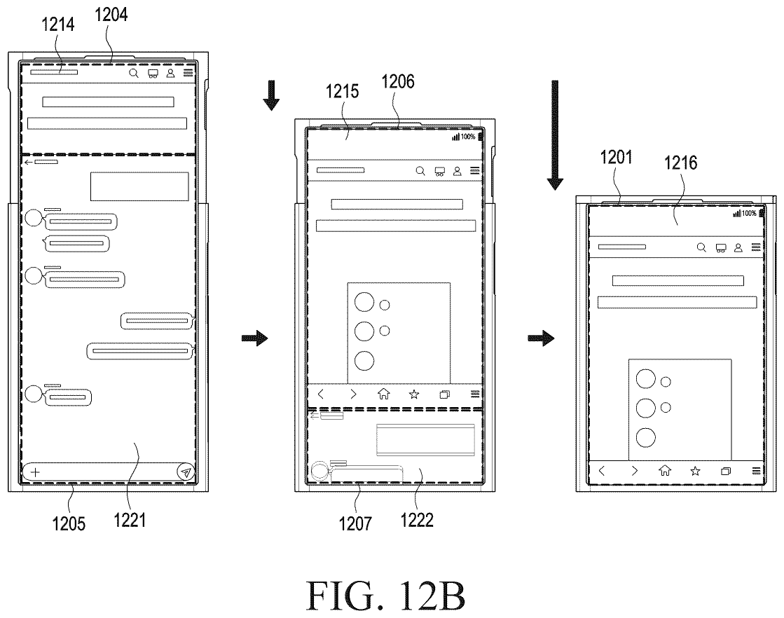

According to an embodiment of the disclosure, the electronic device may display the execution screen of the second application related to the notification message in the third area. According to an embodiment of the disclosure, the operation of adjusting the size of the display area and executing a multi-window while the notification message is being displayed will be described with reference to FIG. 12A below.

According to an embodiment of the disclosure, the electronic device may move the second area, based on receiving a user input while a UI indicating that additional information is able to be displayed in a partial area of the execution screen of the first application is being displayed.

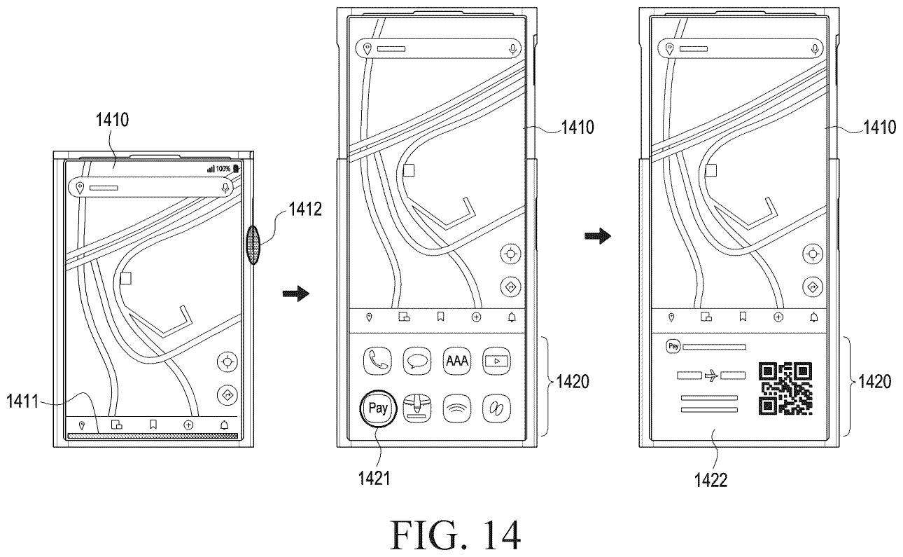

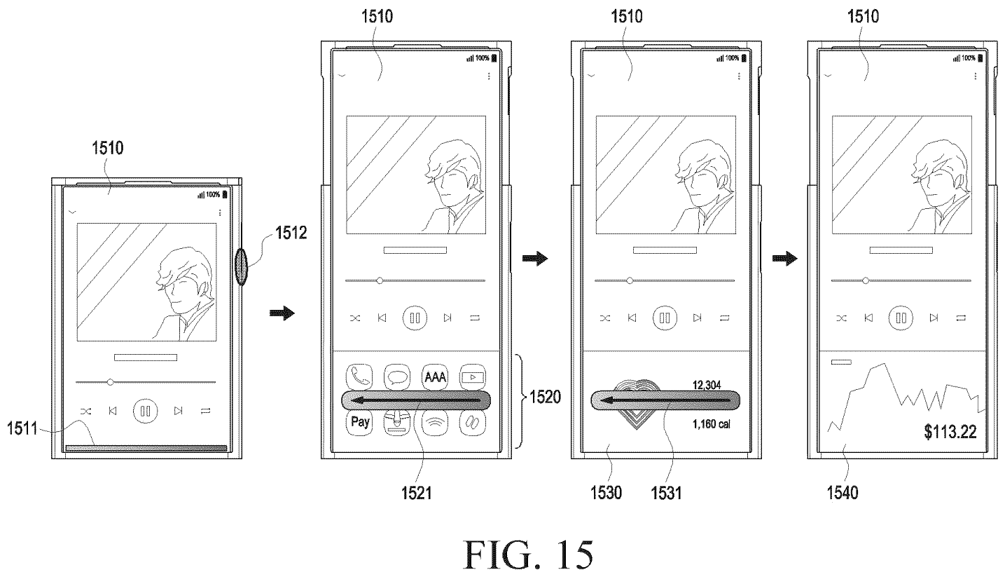

According to an embodiment of the disclosure, the electronic device may display an application list or widget screen related to the first application in a second divided area of the second area. According to an embodiment of the disclosure, an operation when a user input is received while a UI indicating that additional information is able to be displayed is being displayed will be described with reference to FIGS. 14 and 15 below.

In this way, while the area where the execution screen of the second application is displayed increases, the area where the execution screen of the first application is displayed may be reduced, and a portion of the execution screen of the first application may gradually disappear, thereby providing different animation effects to the execution screen of the first application and the execution screen of the second application.

FIG. 9A is a flowchart illustrating an operation in which an electronic device executes a multi-window function while a display area of a flexible display is changed according to an embodiment of the disclosure.

Referring to FIG. 9A, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may display an execution screen of a first application in a first area 910 of a display area in the state in which the size of the display area is a first size, which is the smallest.

According to an embodiment of the disclosure, if a user input 911 for adjusting the size of the display area and executing a multi-window is received (e.g., double-pressing a physical key for adjusting the size of the display area), the electronic device may move a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) to adjust (e.g., increase) the size of the display area from the first size to a second size.

According to an embodiment of the disclosure, based on the movement (e.g., upward movement) of the flexible display, a second area 912 may be disposed at the top of the display area, and a third area 930 may be disposed at the bottom.

According to an embodiment of the disclosure, the second area 912 includes at least a portion of the first area 910, and may be reduced in size, based on the movement of the flexible display. For example, the top of the second area 912 may move (e.g., move upward) to correspond to the movement velocity of the flexible display, and the bottom of the second area 912 may move (e.g., move upward) at a velocity higher than the movement velocity of the flexible display.

According to an embodiment of the disclosure, the second area 912 may be related to the execution screen of the first application. According to an embodiment of the disclosure, a partial area 913 of the execution screen of the first application displayed in the second area 912 may be an area that is to be displayed in a second area 915 that has completed moving. According to an embodiment of the disclosure, the electronic device may cause a remaining area 914 of the execution screen of the first application displayed in the second area 912 to gradually disappear, based on the movement of the flexible display.

According to an embodiment of the disclosure, the third area 930 may include at least a portion of a display area 920 that is newly visible, based on the movement of the flexible display. According to an embodiment of the disclosure, the third area 930 may increase in size, based on the movement of the flexible display. For example, the top of the third area 930 may move (e.g., move upward) at a velocity higher than the velocity at which the flexible display moves.

According to an embodiment of the disclosure, if the movement of the flexible display is completed, the movement of the second area 912 and the movement of the third area 930 may also be completed. According to an embodiment of the disclosure, a boundary may be displayed between the second area 915 that has completed moving and a third area 931 that has completed moving.

According to an embodiment of the disclosure, the size of the second area 915 that has completed moving may be substantially the same as the size of a display area 921 that is newly displayed according to the movement of the flexible display. According to an embodiment of the disclosure, the third area 931 that has completed moving may have the same size as the first area 910 before the movement of the flexible display.

According to an embodiment of the disclosure, the ratio of the horizontal length and the vertical length of the second area 915 that has completed moving may be a reciprocal of the ratio of the horizontal length and the vertical length of the third area 931 that has completed moving.

According to an embodiment of the disclosure, at least a portion of the execution screen of the first application that has been displayed in the first area 910 or a simplified screen may be displayed in the second area 915 that has completed moving. According to an embodiment of the disclosure, a home screen or the execution screen of a second application associated with the first application may be displayed in the third area 931 that has completed moving.

FIG. 9B is a diagram illustrating an operation of an electronic device when a display area of a flexible display is in a second size according to an embodiment of the disclosure.

Referring to FIG. 9B, the electronic device may receive a user input (e.g., a swipe input 941 in FIG. 9B) to control the execution screen of the second application (e.g., a home screen 940) displayed in the third area 931 that has completed moving among the second area 915 that has completed moving and the third area 931 that has completed moving.

According to an embodiment of the disclosure, the electronic device may change the screen of the third area 931 that has completed moving while maintaining the display of the second area 915 that has completed moving.

For example, if the electronic device receives a swipe input 941 that moves from right to left on the home screen 940 displayed in the third area 931 that has completed moving, the electronic device may move the displayed page to the left and display a next page 942. According to an embodiment of the disclosure, the electronic device may maintain video playback in the second area 915 that has completed moving, and display the next page 942 in the third area 931 that has completed moving.

According to an embodiment of the disclosure, if a user input for selecting an application icon 943 included in the next page 942 is received, the electronic device may display an execution screen 944 of an application corresponding to the selected icon 943 in the third area 931 that has completed moving. According to an embodiment of the disclosure, the electronic device may maintain video playback in the second area 915 that has completed moving, and display the execution screen 944 of the application corresponding to the selected icon 943 in the third area 931 that has completed moving.

FIG. 9C is a diagram illustrating an operation of an electronic device when a display area of a flexible display is in a second size according to an embodiment of the disclosure.

Referring to FIG. 9C, the electronic device may receive a user input for selecting a UI 950 displayed on the boundary between a second area that has completed moving (e.g., the second area 915 that has completed moving in FIG. 9B) and a third area that has completed moving (e.g., the third area 931 that has completed moving in FIG. 9B).

According to an embodiment of the disclosure, the electronic device, based on receiving the user input for selecting the UI 950 displayed on the boundary, may display a control UI 951 for controlling at least one of the execution screen of the first application displayed in the second area that has completed moving or the execution screen of the second application displayed in the third area that has completed moving. According to an embodiment of the disclosure, the control UI 951 may include at least one of an icon 952 for switching the positions of the execution screen of the first application and the execution screen of the second application, an icon (not shown) for changing the second execution screen of the second application to the home screen, an icon (not shown) for changing the execution screen of the second application to the execution screen of a recently used application, an icon (not shown) for changing the execution screen of the second application to the execution screen of a recently used application, or an icon for adding a currently displayed multi-window to favorites.

According to an embodiment of the disclosure, if the electronic device receives a user input for selecting the icon 952 for switching the positions of the execution screen of the first application and the execution screen of the second application, as illustrated in FIG. 9D, the electronic device may switch the positions of the execution screen of the first application and the execution screen of the second application.

FIG. 9D is a diagram illustrating an operation of an electronic device when a display area of a flexible display is in a second size according to an embodiment of the disclosure.

Referring to FIG. 9D, the electronic device may move an execution screen 961 of the first application displayed in the second area (e.g., 915 in FIG. 9B), which is the top of the display area, downward. According to an embodiment of the disclosure, the electronic device may move the execution screen of the second application (e.g., the execution screen 944 of the second application in FIG. 9B) displayed in the third area (e.g., 931 in FIG. 9B), which is the bottom of the display area, upward. According to an embodiment of the disclosure, during the movement, at least a portion of the execution screen 961 of the first application and at least a portion of the execution screen 944 of the second application may overlap.

According to an embodiment of the disclosure, the electronic device may move the execution screen 961 of the first application downward while increasing the size thereof (or further displaying content that was not displayed), and may move the execution screen 944 of the second application upward while reducing the size thereof (or not displaying some content of the execution screen of the second application).

According to an embodiment of the disclosure, after the position switching is completed, a first execution screen 971 of the second application with a reduced size may be displayed in the second area 915 that has completed moving, and the execution screen 970 of the first application with an increased size may be displayed in the third area 931 that has completed moving.

According to an embodiment of the disclosure, the electronic device may delete a banner 972 of the second application included in the first execution screen 971 of the second application having the reduced size, and display the second execution screen 973 of the second application without the banner 972. According to an embodiment of the disclosure, the banner 972 may include at least one icon (e.g., an icon “like” or a message transmission icon) for the name and/or control of the application. Since the banner 972 is not displayed, the second area 915 that has completed moving may display more content on the second execution screen 973 than on the first execution screen 971 of the second application.

FIG. 10 is a diagram illustrating an operation of generating a third area for a multi-window function while a display area of a flexible display is changed in an electronic device according to an embodiment of the disclosure.

Referring to FIG. 10, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may increase a display area of a third area in a direction different from a flexible movement direction while a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) is moving.

According to an embodiment of the disclosure, while the flexible display moves upward (e.g., in the +Y direction), an execution screen 1010 of a first application displayed in a second area may move upward (e.g., in the +Y direction). According to an embodiment of the disclosure, the execution screen 1010 of the first application may be reduced while moving upward.

According to an embodiment of the disclosure, the electronic device may increase an execution screen 1020, 1021, 1022, or 1023 of a second application displayed in the third area by moving it in a horizontal direction (e.g., the +X direction and/or the −X direction) while the flexible display is moving upward.

For example, the electronic device may display the execution screen 1020 of the second application displayed in the third area so as to move from the left end of the display area to the center (e.g., in the +X direction) and move from the right end to the center (e.g., the −X direction) while the flexible display is moving upward.

According to an embodiment of the disclosure, the electronic device may display the execution screen 1021 of the second application displayed in the third area so as to move from the center of the display area to both ends (e.g., in the −X direction and the +X direction) while the flexible display is moving upward.

According to an embodiment of the disclosure, the electronic device may display the execution screen 1022 of the second application displayed in the third area so as to move from the left end of the display area to the right (e.g., in the +X direction) while the flexible display is moving upward.

According to an embodiment of the disclosure, the electronic device may display the execution screen 1023 of the second application displayed in the third area so as to move from the right end of the display area to the left (e.g., in the −X direction) while the flexible display is moving upward.

As described above, the electronic device may increase the execution screen of the second application in a direction different from the movement direction of the execution screen of the first application.

FIG. 11A is a diagram illustrating an operation in which a display area of a flexible display is changed while a camera application is running in an electronic device according to an embodiment of the disclosure.

Referring to FIG. 11A, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may display an execution screen of a first application in a first area (e.g., the first area 710 in FIG. 7 or the first area 910 in FIG. 9A) of a display area in the state where the size of the display area is a first size, which is the smallest. For example, the execution screen of the first application may be an execution screen 1110 of a front camera. According to an embodiment of the disclosure, the horizontal length and the vertical length of the first area may be 9:16.

According to an embodiment of the disclosure, when a user input (e.g., double-pressing a physical key for adjusting the size of the display area) for adjusting the size of the display area and executing a multi-window is received while the execution screen 1110 of the front camera is being displayed, the electronic device may move a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) to adjust (e.g., increase) the size of the display area from the first size to a second size.

According to an embodiment of the disclosure, the electronic device may display at least a portion of the execution screen of the first application or a simplified screen in a second area (e.g., the second area 712 that has been reduced in FIG. 7 or the second area 915 that has completed moving in FIG. 9A) that is the top of the increased display area, based on the movement of the flexible display. According to an embodiment of the disclosure, the ratio of the horizontal length and the vertical length of the second area may be 16:9.

For example, the electronic device may display, in the second area, a screen 1111 obtained by reducing a preview screen of the execution screen of the front camera to the size of the second area. For example, the screen 1111 that has been reduced from the preview screen of the front camera may be displayed in the second area while maintaining the ratio of 9:16. According to an embodiment of the disclosure, the area of the second area, excluding the screen 1111 that has been reduced from the preview screen, may be processed in a single color (e.g., black, white, or gray).

According to an embodiment of the disclosure, the electronic device may display an execution screen of a second application related to the first application in a third area that is the bottom of the increased display area (e.g., the third area 741 whose size has been increased in FIG. 7 or the third area 931 that completed moving in FIG. 9A), based on the movement of the flexible display. For example, the electronic device may display an execution screen 1120 of the rear camera in the third area. According to an embodiment of the disclosure, a ratio of a horizontal length and a vertical length of the third area may be 9:16.

According to an embodiment of the disclosure, the execution screen 1120 of the rear camera may include a UI for camera settings and a shooting button. According to an embodiment of the disclosure, if a user input for selecting a shooting button included in the execution screen 1120 of the rear camera is received, the electronic device may perform shooting with both the front camera and the rear camera and provide an option of whether to store two images separately or store a single image with the two images disposed vertically.

According to an embodiment of the disclosure, when receiving a user input 1122 for selecting a UI displayed on a boundary between the second area and the third area, the electronic device may proceed to (1) and perform the operation shown in FIG. 11B.

According to an embodiment of the disclosure, if the electronic device is rotated 90 degrees, the electronic device may display, in the second area, a preview screen 1112 of the front camera whose size is adjusted to fit the rotated second area. According to an embodiment of the disclosure, since the ratio of the preview screen 1112 of the front camera is 9:16, and since the ratio of the horizontal length and vertical length of the second area becomes 9:16 according to the rotation of the electronic device, the preview screen 1112 of the front camera may be displayed in the entire area of the second area.

According to an embodiment of the disclosure, if the electronic device is rotated 90 degrees, the electronic device may move the setting UI for the rear camera and the shooting button, which are disposed at the top 1150 and bottom 1151 of the execution screen 1120 of the rear camera, to the left and right 1160 and 1161, and display an execution screen 1121 of the rear camera in which the ratio of the rear camera preview screen is changed.

FIG. 11B is a diagram illustrating an operation in which a display area of a flexible display is changed while a camera application is running in an electronic device according to an embodiment of the disclosure.

Referring to FIG. 11B, the electronic device may perform the operation subsequent to (1) illustrated in FIG. 11A.

According to an embodiment of the disclosure, when the UI displayed on the boundary between the second area and the third area is selected, the electronic device may display a control UI 1130 for controlling at least one of the screen reduced from the preview screen of the front camera displayed in the second area and the execution screen of the rear camera displayed in the third area.

According to an embodiment of the disclosure, the control UI 1130 may include at least one of a UI 1131 for switching the positions of the execution screen of the first application and the execution screen of the second application, a UI for adding the currently displayed multi-window to favorites, or a UI for displaying a home screen in the third area.

According to an embodiment of the disclosure, based on receiving a user input for selecting the UI 1131 for switching the positions of the execution screen of the first application and the execution screen of the second application, the electronic device may display a preview screen 1123 of the rear camera in the second area and an execution screen 1113 of the front camera in the third area.

According to an embodiment of the disclosure, if the electronic device is rotated 90 degrees, the electronic device may display, in the second area, a preview screen 1124 of the rear camera that is resized to fit the rotated second area. According to an embodiment of the disclosure, the electronic device may display a preview screen 1124 of the rear camera that is resized to fit the second area by excluding both ends of the rear camera preview screen in the second area.

According to an embodiment of the disclosure, if the electronic device is rotated 90 degrees, the electronic device may move the front camera setting UI and shooting button disposed at a top 1152 and bottom 1153 of the execution screen 1113 of the front camera to the left and right 1162 and 1163, and display an execution screen 1114 of the front camera having a changed ratio of the preview screen of the front camera.

FIG. 12A is a diagram illustrating an operation in which a display area of a flexible display is changed based on a user input while a notification message is displayed in an electronic device according to an embodiment of the disclosure.

Referring to FIG. 12A, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may display an execution screen 1210 of a first application in a first area 1201 of a display area when the size of the display area is a first size, which is the smallest.

According to an embodiment of the disclosure, if a notification event occurs, the electronic device may display a notification message 1211 so as to overlap the execution screen 1210 of the first application. For example, the notification message 1211 may be a pop-up screen.

According to an embodiment of the disclosure, if a user input 1212 for adjusting the size of the display area and executing a multi-window (e.g., double-pressing a physical key for adjusting the size of the display area) is received while the notification message 1211 is being displayed, the electronic device may move a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) to adjust (e.g., increase) the size of the display area from the first size to a second size.

According to an embodiment of the disclosure, based on the movement (e.g., upward movement) of the flexible display, a second area 1202 may be disposed at the top of the display area, and a third area 1203 may be disposed at the bottom. According to an embodiment of the disclosure, the electronic device may display an execution screen 1220 of a second application related to the notification message 1211 in the third area 1203. According to an embodiment of the disclosure, based on the third area 1203 increasing in size from the bottom of the display area, the execution screen 1220 of the second application may be displayed to come out from the bottom of the display area.

According to an embodiment of the disclosure, based on the movement (e.g., upward movement) of the flexible display, the electronic device may display a partial area 1213 of the execution screen of the first application as the size of the second area 1202 is reduced. For example, the partial area 1213 of the execution screen of the first application may be the top area of the execution screen 1210 of the first application.

According to an embodiment of the disclosure, the electronic device, based on the completion of the movement (e.g., upward movement) of the flexible display, may display a partial area 1214 of the first application execution screen in a second area 1204 that has completed moving and display an execution screen 1221 of the second application having an increased size in a third area 1205 that has completed moving. According to an embodiment of the disclosure, the execution screen 1221 of the second application having an increased size may include an area that was not visible during the movement of the flexible display.

FIG. 12B is a diagram illustrating an operation in which a display area of a flexible display is changed based on a user input while a notification message is displayed in an electronic device according to an embodiment of the disclosure.

Referring to FIG. 12B, when the size of the display area is a second size, which is the largest, the electronic device may display an execution screen 1214 of a first application in a second area 1204 at the top and display an execution screen 1221 of a second application in a third area 1205 at the bottom.

According to an embodiment of the disclosure, if a user input for adjusting the size of the display area and executing a multi-window (e.g., double-pressing a physical key for adjusting the size of the display area) is received when the size of the display area is the largest second size, the electronic device may move the flexible display (e.g., move the same downward) to adjust (e.g., reduce) the size of the display area from the second size to a first size.

According to an embodiment of the disclosure, based on the movement (e.g., downward movement) of the flexible display, the electronic device may increase the size of a second area 1206. According to an embodiment of the disclosure, a first application execution screen 1215 having an increased size may be displayed in the second area 1206 having an increased size. According to an embodiment of the disclosure, based on the movement (e.g., downward movement) of the flexible display, the electronic device may reduce the size of a third area 1207. According to an embodiment of the disclosure, based on the top of the third area 1207 moving downward, an execution screen 1222 of the second application may be displayed so as to go into the bottom of the display area.

According to an embodiment of the disclosure, based on the completion of the movement (e.g., downward movement) of the flexible display, the second area and the third area may disappear, and the electronic device may display a first application execution screen 1216 having an increased size in the first area 1201 of the display area.

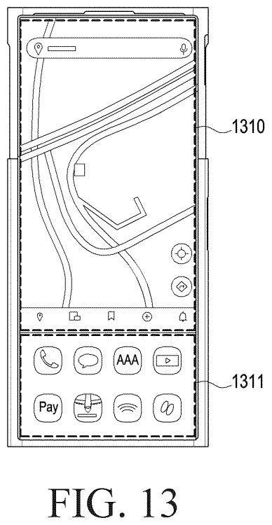

FIG. 13 is a diagram illustrating an area of a multi-window, based on a change in a display area of a flexible display, in an electronic device according to an embodiment of the disclosure.

Referring to FIG. 13, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B), based on movement (e.g., upward movement) of a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B), may move a first area 1310 to correspond to the movement of the flexible display, while maintaining the size of the first area 1310. According to an embodiment of the disclosure, the electronic device may move an execution screen of a first application displayed in the first area 1310 to correspond to the movement of the flexible display.

According to an embodiment of the disclosure, the electronic device may display additional information related to the first application in a display area 1311 that is newly visible from the outside, based on the movement of the flexible display. For example, the additional information may be an icon list and/or widget of applications related to the first application.

FIG. 14 is a diagram illustrating an operation in which a display area of a flexible display is changed based on a user input while a notification UI is displayed in an electronic device according to an embodiment of the disclosure.

Referring to FIG. 14, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may display an execution screen 1410 of a first application in a first area of a display area when the size of the display area is a first size, which is the smallest.

According to an embodiment of the disclosure, the electronic device may display a lightning notification 1411 for displaying additional information related to the first application so as to overlap the execution screen 1410 of the first application.

For example, the lightning notification 1411 may be displayed for a configured time after the execution screen 1410 of the first application is displayed, or may be displayed periodically for a configured time. According to an embodiment of the disclosure, the electronic device may display a lightning notification if it is identified that additional information is required based on a user input entered through the execution screen 1410 of the first application.

According to an embodiment of the disclosure, the lightning notification 1411 may be displayed in a highlighted form at the bottom of the display area or may be displayed in an object form in an area.

According to an embodiment of the disclosure, if a user input 1412 for adjusting the size of the display area and executing a multi-window (e.g., double-pressing a physical key for adjusting the size of the display area) is received while the lightning notification 1411 is being displayed, the electronic device may move a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) to adjust (e.g., increase) the size of the display area from the first size to a second size.

According to an embodiment of the disclosure, the electronic device may move the execution screen 1410 of the first application to correspond to the movement of the flexible display, based on the movement of the flexible display.

According to an embodiment of the disclosure, the electronic device, based on the movement of the flexible display, may display additional information related to the first application in a display area 1420 that is newly visible. For example, the additional information may be a list of icons and/or widgets of frequently used or recently used applications related to the first application.

According to an embodiment of the disclosure, based on receiving a user input for selecting one icon 1421 from the icon list of the applications, the electronic device may display a widget 1422 related to the selected icon in the newly visible display area 1420.

According to an embodiment of the disclosure, if the first application is a map application and if the location is identified to be near an airport, the electronic device may provide a lightning notification 1411. According to an embodiment of the disclosure, if a user input 1412 for adjusting the size of the display area and executing a multi-window is received while the lightning notification 1411 is being displayed, the electronic device may display a list of icons of applications related to payment, airlines, or music.

According to an embodiment of the disclosure, if the execution screen 1410 of the first application contains many foreign languages, the electronic device may provide a lightning notification 1411. According to an embodiment of the disclosure, if a user input 1412 for adjusting the size of the display area and executing a multi-window is received while a lightning notification 1411 is being displayed, the electronic device may display a list of icons including application icons related to foreign language translation.

FIG. 15 is a diagram illustrating an operation in which a display area of a flexible display is changed based on a user input while a notification UI is displayed in an electronic device according to an embodiment of the disclosure.

Referring to FIG. 15, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may display an execution screen 1510 of a first application in a first area of a display area when the size of the display area is a first size, which is the smallest.

According to an embodiment of the disclosure, the electronic device may display a lightning notification 1511 for displaying additional information related to the first application so as to overlap the execution screen 1510 of the first application.

According to an embodiment of the disclosure, if a user input 1512 for adjusting the size of the display area and executing a multi-window (e.g., double-pressing a physical key for adjusting the size of the display area) is received while the lightning notification 1511 is being displayed, the electronic device may move a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) to adjust (e.g., increase) the size of the display area from the first size to a second size.

According to an embodiment of the disclosure, based on the movement of the flexible display, the electronic device may move the execution screen 1510 of the first application to correspond to the movement of the flexible display.

According to an embodiment of the disclosure, the electronic device may display additional information related to the first application in a display area 1520 that is newly visible, based on the movement of the flexible display. For example, the additional information may be a list of icons and/or widgets of frequently used or recently used applications related to the first application.

According to an embodiment of the disclosure, if the electronic device receives a swipe motion 1521 from right to left while the list of icons is being displayed in the newly displayed display area 1520, the electronic device may cause the list of icons to disappear to the left, based on the direction of the swipe motion 1521, and display a first widget screen 1530, which is the next page.

According to an embodiment of the disclosure, if a swipe motion 1531 from right to left is received on the first widget screen 1530, the first widget screen 1530 may disappear to the left, based on the direction of the swipe motion 1531, and a second widget screen 1540, which is the next page, may be displayed.

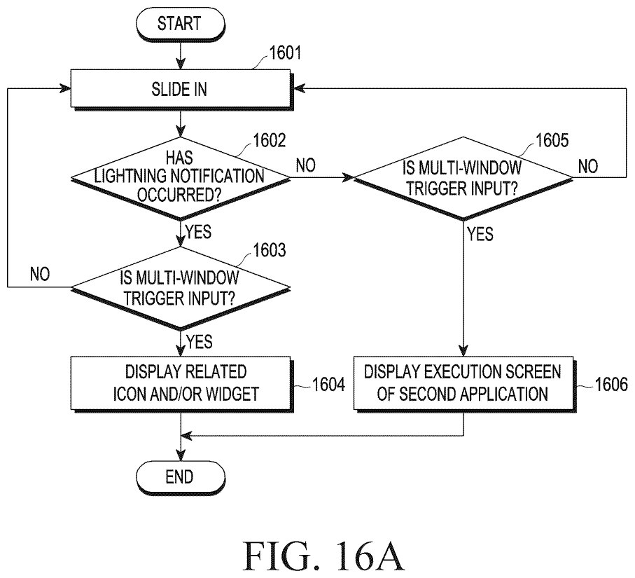

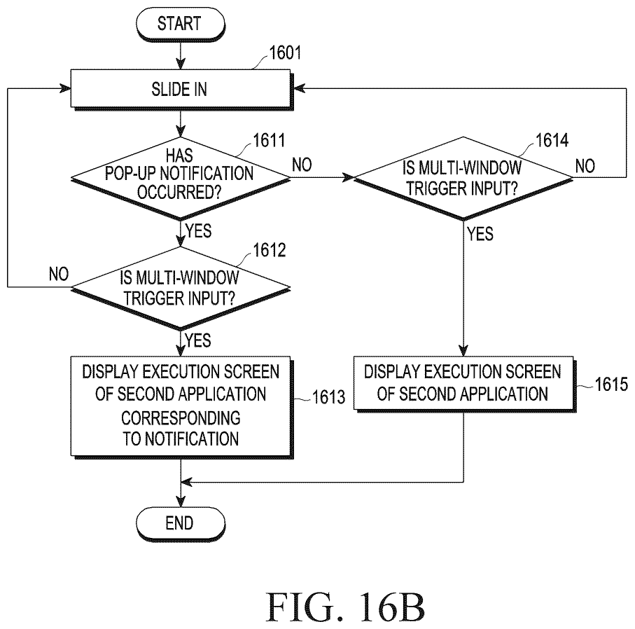

FIG. 16A is a flowchart illustrating an operation of an electronic device when a user input for changing a display area of a flexible display is received according to an embodiment of the disclosure.

Referring to FIG. 16A, in operation 1601, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may be in a slide-in state. According to an embodiment of the disclosure, in the case where a display area of a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) of the electronic device is variable between a first size and a second size, the slide-in state may indicate the case where the display area is in the first size.

According to an embodiment of the disclosure, when the display area is in the first size, the electronic device may display a first application screen in at least a partial area of the display area.

According to an embodiment of the disclosure, in operation 1602, the electronic device may identify whether or not a lightning notification occurs. For example, the lightning notification (e.g., the lightning notification 1411 in FIG. 14 or the lightning notification 1511 in FIG. 15) may be a UI notifying that additional information displayed in a partial area of the execution screen of the first application is able to be displayed. According to an embodiment of the disclosure, the lightning notification (e.g., the lightning notification 1411 in FIG. 14 or the lightning notification 1511 in FIG. 15) may be a UI notifying that additional information displayed in a partial area of the execution screen of the first application is able to be displayed. According to an embodiment of the disclosure, the lightning notification may be displayed for a configured time immediately after displaying the execution screen of the first application, or may be displayed periodically for a configured time. According to an embodiment of the disclosure, the electronic device may display a lightning notification if it is identified that additional information is required, based on a user input entered through the execution screen of the first application.

According to an embodiment of the disclosure, if a lightning notification occurs (Yes in operation 1602), the electronic device may identify whether or not a multi-window trigger is input in operation 1603. According to an embodiment of the disclosure, the multi-window trigger input is a user input for adjusting the size of the display area and executing a multi-window function, and may be distinguished from a user input for adjusting the size of the display area.

According to an embodiment of the disclosure, if it is identified that a multi-window trigger is input (Yes in operation 1603), the electronic device may display a related icon and/or widget in operation 1604. According to an embodiment of the disclosure, based on receiving a multi-window trigger while the lightning notification is being displayed, the electronic device may display an icon and/or widget related to the first application. For example, the icon and/or widget related to the first application may be an icon and/or widget of an application frequently used together when the first application is executed or a recently used application.

According to an embodiment of the disclosure, if a multi-window trigger is not input (No in operation 1603), the electronic device may proceed to operation 1601 and remain in the slide-in state. According to an embodiment of the disclosure, if a multi-window trigger is not input, the electronic device may maintain the size of the display area at the first size. According to an embodiment of the disclosure, if a user input for adjusting the size of the display area, instead of the multi-window trigger, is received, the electronic device may move the flexible display to increase the size of the display area and display an additional area of the execution screen of the first application in a display area that is newly visible.

According to an embodiment of the disclosure, if a lightning notification does not occur (No in operation 1602), the electronic device may identify whether or not a multi-window trigger is input in operation 1605. According to an embodiment of the disclosure, operation 1605 may be substantially the same as operation 1603.

According to an embodiment of the disclosure, although operation 1603 or operation 1605 is performed after operation 1602 in FIG. 16A, the disclosure is not limited thereto, and operation 1602 may be performed after operation 1603 or operation 1605, or operation 1602 and at least some of operation 1603 or operation 1605 may be performed simultaneously.

According to an embodiment of the disclosure, if it is identified that a multi-window trigger is input in the state in which a lightning notification does not occur (Yes in operation 1605), the electronic device may display an execution screen of a second application in operation 1606. According to an embodiment of the disclosure, if a multi-window trigger is input when a lightning notification is not displayed, the electronic device may move the flexible display to increase the size of the display area, and further display an execution screen of a second application related to the first application. According to an embodiment of the disclosure, the execution screen of the second application may be a home screen. According to an embodiment of the disclosure, if the first application is the front camera or the rear camera, the execution screen of the second application may be the remaining application among the front camera and the rear camera.

According to an embodiment of the disclosure, if the multi-window trigger is not input when the lightning notification does not occur (No in operation 1605), the electronic device may proceed to operation 1601 to remain in the slide-in state. According to an embodiment of the disclosure, if a multi-window trigger is not input, the electronic device may maintain the size of the display area at the first size. According to an embodiment of the disclosure, if a user input for adjusting the size of the display area, instead of a multi-window trigger, is received, the electronic device may move the flexible display to increase the size of the display area, and display an additional area of the execution screen of the first application in a display area that is newly visible.

FIG. 16B is a flowchart illustrating an operation of an electronic device when a user input for changing a display area of a flexible display is received according to an embodiment of the disclosure.

Referring to FIG. 16B, in operation 1601, the electronic device may be in the slide-in state. According to an embodiment of the disclosure, in the case where a display area of a flexible display of the electronic device is variable between a first size and a second size, the slide-in state may indicate the case where the display area is in the first size. According to an embodiment of the disclosure, operation 1601 in FIG. 16B may be substantially the same as operation 1601 in FIG. 16A.

According to an embodiment of the disclosure, in operation 1611, the electronic device may identify whether or not a pop-up notification occurs. According to an embodiment of the disclosure, based on a notification event occurring, the electronic device may display a notification message as a pop-up screen. According to an embodiment of the disclosure, the notification message may be displayed for a configured time and disappear.

According to an embodiment of the disclosure, if a pop-up notification occurs (Yes in operation 1611), the electronic device may identify whether or not a multi-window trigger is input in operation 1612. According to an embodiment of the disclosure, the multi-window trigger input is a user input for adjusting the size of the display area and executing a multi-window function, and may be distinguished from a user input for adjusting the size of the display area.

According to an embodiment of the disclosure, if it is identified that a multi-window trigger is input while a pop-up notification is being displayed (Yes in operation 1612), the electronic device may display an execution screen of a second application corresponding to the notification in operation 1613. For example, if a multi-window trigger is input while a notification message is being displayed based on the reception of a new message, the electronic device may move the flexible display to increase the display area and further display an execution screen of a message application.

According to an embodiment of the disclosure, if a multi-window trigger is not input (No in operation 1612), the electronic device may proceed to operation 1601 and remain in the slide-in state. According to an embodiment of the disclosure, the electronic device may maintain the size of the display area at the first size if a multi-window trigger is not input. According to an embodiment of the disclosure, if a user input for adjusting the size of the display area, instead of the multi-window trigger, is received, the electronic device may move the flexible display to increase the size of the display area and display an additional area of the execution screen of the first application in a display area that is newly visible.

According to an embodiment of the disclosure, if a pop-up notification does not occur (No in operation 1611), the electronic device may identify whether or not a multi-window trigger is input in operation 1614. According to an embodiment of the disclosure, operation 1614 may be substantially the same as operation 1602.

According to an embodiment of the disclosure, although operation 1612 or operation 1614 is performed after operation 1611 in FIG. 16B, the disclosure is not limited thereto, and operation 1611 may be performed after operation 1612 or operation 1614, or operation 1611 and at least some of operation 1612 or operation 1614 may be performed simultaneously.

According to an embodiment of the disclosure, if it is identified that a multi-window trigger is input when a pop-up notification is not displayed (Yes in operation 1614), the electronic device may display an execution screen of a second application in operation 1615. According to an embodiment of the disclosure, if a multi-window trigger is input when a pop-up notification is not displayed, the electronic device may move the flexible display to increase the size of the display area, and further display an execution screen of a second application related to the first application. According to an embodiment of the disclosure, the execution screen of the second application may be a home screen. According to an embodiment of the disclosure, if the first application is the front camera or the rear camera, the execution screen of the second application may be the remaining application among the front camera and the rear camera.

According to an embodiment of the disclosure, if the multi-window trigger is not input when a pop-up notification is not displayed (No in operation 1614), the electronic device may proceed to operation 1601 and remain in the slide-in state. According to an embodiment of the disclosure, if a multi-window trigger is not input, the electronic device may maintain the size of the display area at the first size. According to an embodiment of the disclosure, if a user input for adjusting the size of the display area, instead of the multi-window trigger, is received, the electronic device may move the flexible display to increase the size of the display area, and display an additional area of the execution screen of the first application in a display area that is newly visible.

As described above, the electronic device may provide different multi-window screens, based on whether the multi-window trigger is input when a lightning notification occurs, when a pop-up notification occurs, or when no notification occurs.

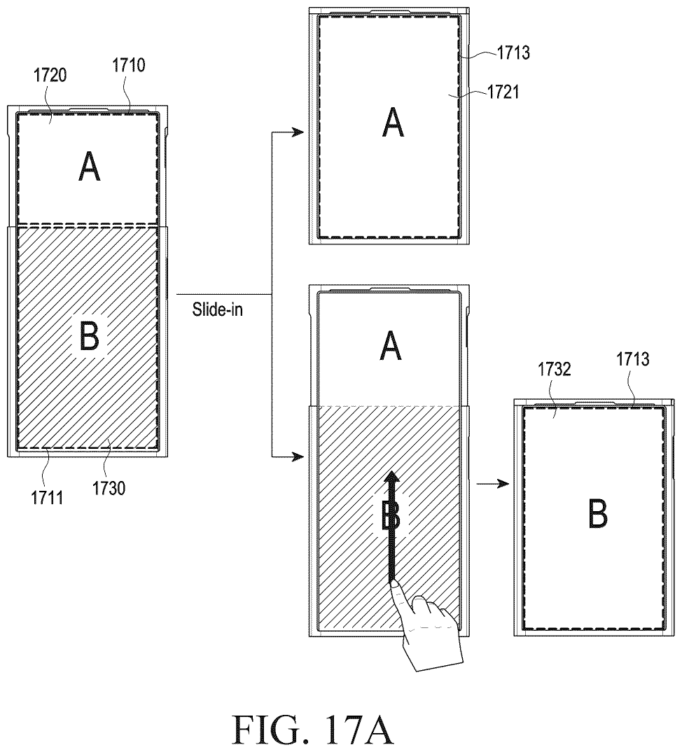

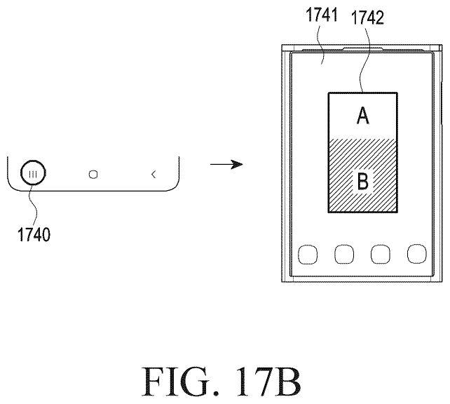

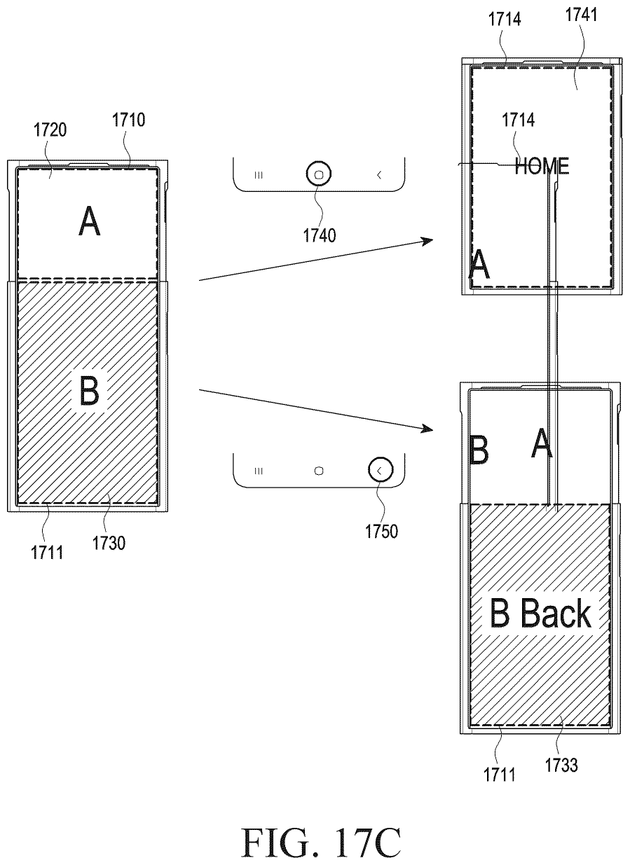

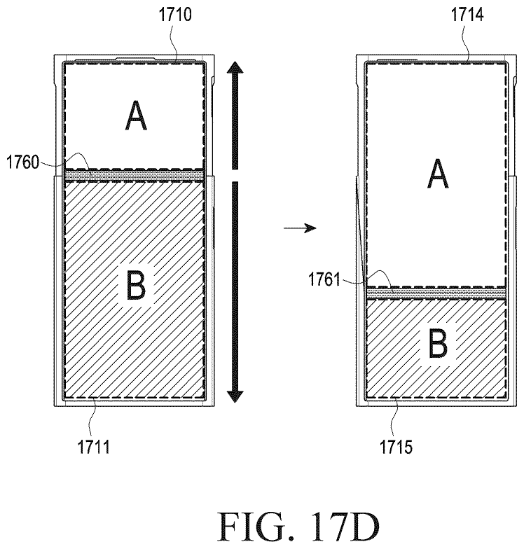

FIG. 17A is a diagram illustrating an operation of an electronic device when a size of a display area of a flexible display is reduced according to an embodiment of the disclosure.

Referring to FIG. 17A, an electronic device (e.g., the electronic device 101 in FIG. 1, the processor 120 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may dispose a second area 1710 at the top and a third area 1711 at the bottom when the display area is in a second size, which is the largest. According to an embodiment of the disclosure, an execution screen 1720 (e.g., A) of a first application may be displayed in the second area 1710, and an execution screen 1730 (e.g., B) of a second application may be displayed in the third area 1711.

According to an embodiment of the disclosure, based on receiving a user input for adjusting the display area from the second size to a first size (e.g., slide-in), the electronic device may display an execution screen 1721 of the first application with an increased size in a first area 1713 of the display area, which is in the first size.

According to an embodiment of the disclosure, if a user input 1731 of swiping from the bottom to the top on the execution screen of the second application is received while adjusting the display area from the second size to the first size, the electronic device may display an execution screen 1732 of the second application in the first area 1713 of the display area, which is in the first size.

As described above, in the operation of reducing the display area, the execution screen of the application to be displayed in the reduced display area may vary depending on the user input.

FIG. 17B is a diagram illustrating an operation of an electronic device when a user input for displaying a recently executed application is received after a size of a display area of a flexible display is reduced according to an embodiment of the disclosure.

Referring to FIG. 17B, if the electronic device receives a user input for selecting a button 1740 for identifying a recently executed application when the size of the display area is the first size, the electronic device may display a multi-window screen 1742 shown in FIG. 17A on a screen 1741 for identifying a recently executed application.

According to an embodiment of the disclosure, if a user input for selecting the multi-window screen 1742 is received, the electronic device may increase the display area from the first size to the second size and display the execution screen of the first application and the execution screen of the second application to correspond to the multi-window screen 1742.

FIG. 17C is a diagram illustrating an operation of an electronic device depending on a button selected when a display area of a flexible display is in a second size according to an embodiment of the disclosure.

Referring to FIG. 17C, the electronic device may dispose the second area 1710 at the top and the third area 1711 at the bottom when the display area is in the largest second size. According to an embodiment of the disclosure, an execution screen 1720 (e.g., A) of the first application may be displayed in the second area 1710, and an execution screen 1730 (e.g., B) of the second application may be displayed in the third area 1711.

According to an embodiment of the disclosure, if the electronic device receives a user input for selecting a home key 1740 included in a control bar disposed at the bottom of the display area, the electronic device may display a home screen 1741 on an entire display area 1714 of the second size.

According to an embodiment of the disclosure, if the electronic device receives a user input for selecting a back key 1750 included in a control bar disposed at the bottom of the display area, the electronic device may execute a back movement in the second area 1710 or the third area 1711, which is recently controlled. For example, the electronic device may display, in the third area 1711, an execution screen 1733 of the application that was previously executed before the execution screen 1730 of the second application.

FIG. 17D is a diagram illustrating an operation of adjusting a displayed boundary when a display area of a flexible display is in a second size in an electronic device according to an embodiment of the disclosure.

Referring to FIG. 17D, the electronic device may adjust the sizes of the second area and the third area, based on a user input for selecting a boundary 1760 between the second area 1710 and the third area 1711 and moving the same upward or downward.

For example, based on a user input of selecting the boundary 1760 between the second area 1710 and the third area 1711 and moving the same downward, the electronic device may display the boundary 1761 moved downward, and display the second area 1714 with an increased size and a third area 1715 with a reduced size, based on the moved boundary 1761.

According to an embodiment of the disclosure, an electronic device (e.g., the electronic device 101 in FIG. 1, the electronic device 101 in FIG. 2, the electronic device 101 in FIG. 3, the electronic device 101 in FIG. 4, the electronic device 101 in FIG. 5A, or the electronic device 101 in FIG. 5B) may include a housing (e.g., the housing 210 in FIG. 2, the first housing 201 in FIG. 2, the second housing 202 in FIG. 2, the housing 210 in FIG. 3, the first housing 201 in FIG. 3, the second housing 202 in FIG. 3, the first housing 201 in FIG. 4, the second housing 202 in FIG. 4, the first housing 201 in FIG. 5A, the second housing 202 in FIG. 5A, the first housing 201 in FIG. 5B, or the second housing 202 in FIG. 5B), a flexible display (e.g., the display module 160 in FIG. 1, the display 203 in FIG. 2, the display 203 in FIG. 3, the display 231 in FIG. 4, the display 231 in FIG. 5A, or the display 231 in FIG. 5B) in which a size of a display area visible from outside of the electronic device is variable from a first size to a second size, based on movement of at least a portion of the housing, memory (e.g., the memory 130 in FIG. 1) storing instructions, and at least one processor (e.g., the processor 120 in FIG. 1).

According to an embodiment of the disclosure, the instructions, when executed by the at least one processor, may cause the electronic device to display an execution screen of a first application in a first area of the flexible display when the display area is in the first size.

According to an embodiment of the disclosure, the instructions, when executed by the at least one processor, may cause the electronic device to display at least a portion of the execution screen of the first application or a simplified screen of the execution screen of the first application in a second area including at least a portion of the first area while the display area is changed from the first size to the second size.

According to an embodiment of the disclosure, the instructions, when executed by the at least one processor, may cause the electronic device to display an execution screen of a second application in a third area including at least a portion of a display area newly visible from the outside of the electronic device while the display area is changed from the first size to the second size.

According to an embodiment of the disclosure, a velocity at which the execution screen of the second application is displayed may be different from a velocity at which the flexible display moves.

According to an embodiment of the disclosure, the third area may be disposed below the second area.

According to an embodiment of the disclosure, the instructions, when executed by the at least one processor, may cause the electronic device to increase a size of the third area, based on moving a top of the third area upward from a bottom of the display area.

According to an embodiment of the disclosure, a velocity at which the execution screen of the second application is displayed in the third area may be higher than a velocity at which the flexible display moves.

According to an embodiment of the disclosure, the instructions, when executed by the at least one processor, may cause the electronic device to increase a size of the third area, based on moving at least a portion of the third area from at least one of a left end or a right end of the third area.

According to an embodiment of the disclosure, a direction in which the execution screen of the second application is displayed in the third area may be different from a direction in which the flexible display moves.

According to an embodiment of the disclosure, the instructions, when executed by the at least one processor, may cause the electronic device to reduce a size of the second area where the execution screen of the first application is displayed while a size of the third area where the execution screen of the second application is displayed is increased.

According to an embodiment of the disclosure, the instructions, when executed by the at least one processor, may cause the electronic device to make a partial area of the execution screen of the first application gradually disappear while the size of the second area is reduced.

According to an embodiment of the disclosure, the instructions, when executed by the at least one processor, may cause the electronic device to display the remaining area, excluding the partial area, of the execution screen of the first application, or the simplified screen, based on completion of the reduction in the size of the second area.

According to an embodiment of the disclosure, the simplified screen may include a screen in which an image included in the execution screen of the first application is changed based on the second area, or a screen in which a preview screen is changed based on the second area.

According to an embodiment of the disclosure, the instructions, when executed by the at least one processor, may cause the electronic device to display a partial area of the execution screen of the second application to overlap a partial area of the execution screen of the first application while a size of the third area, where the execution screen of the second application is displayed, increases.

According to an embodiment of the disclosure, the instructions, when executed by the at least one processor, may cause the electronic device to display a boundary between the second area and the third area, based on completion of the increase in the size of the third area where the execution screen of the second application is displayed.

According to an embodiment of the disclosure, the instructions, when executed by the at least one processor, may cause the electronic device to display at least one UI for controlling at least one of the execution screen of the first application or the execution screen of the second application in a partial area of the boundary.

According to an embodiment of the disclosure, the at least one UI may include at least one of a UI for changing positions of the execution screen of the first application and the execution screen of the second application, a UI for changing the second execution screen of the second application to a home screen, or a UI for changing the execution screen to the execution screen to an execution screen of a recently used application.

According to an embodiment of the disclosure, a ratio of a horizontal length and a vertical length of the second area may be a reciprocal of a ratio of a horizontal length and a vertical length of the third area in the state where increasing a size of the third area, where the execution screen of the second application is displayed, is completed.

According to an embodiment of the disclosure, the electronic device may further include a front camera.

According to an embodiment of the disclosure, the electronic device may further include a rear camera.

According to an embodiment of the disclosure, the instructions, when executed by the at least one processor, may cause the electronic device to display a preview screen of the execution screen of the front camera or the execution screen of the rear camera in the second area, based on the execution screen of the first application displayed in the first area being the execution screen of the front camera or the execution screen of the rear camera.

According to an embodiment of the disclosure, the instructions, when executed by the at least one processor, may cause the electronic device to display the remaining one of the execution screen of the front camera or the execution screen of the rear camera, as the execution screen of the second application, in the third area.

According to an embodiment of the disclosure, the execution screen of the second application may be a home screen.

According to an embodiment of the disclosure, the instructions, when executed by the at least one processor, may cause the electronic device to change the display area from the first size to the second size, based on receiving a user input for adjusting the size of the display area and executing a multi-window function when the display area is in the first size.

According to an embodiment of the disclosure, the instructions, when executed by the at least one processor, may cause the electronic device to display a notification message in the state in which the execution screen of the first application is displayed in the first area.

According to an embodiment of the disclosure, the instructions, when executed by the at least one processor, may cause the electronic device to change the display area from the first size to the second size, based on receiving the user input in the state in which the notification message is displayed.

According to an embodiment of the disclosure, the instructions, when executed by the at least one processor, may cause the electronic device to display the execution screen of the second application related to the notification message in the third area.

According to an embodiment of the disclosure, a method of controlling an electronic device may include displaying an execution screen of a first application in a first area of a flexible display when a display area of the flexible display visible from outside of the electronic device is in a first size.

According to an embodiment of the disclosure, the method of controlling an electronic device may include displaying at least a portion of the execution screen of the first application or a simplified screen of the execution screen of the first application in a second area including at least a portion of the first area while the display area is changed from the first size to a second size.

According to an embodiment of the disclosure, the method of controlling an electronic device may include displaying an execution screen of a second application in a third area including at least a portion of the display area newly visible from the outside of the electronic device while the display area is changed from the first size to the second size.

According to an embodiment of the disclosure, a velocity at which the execution screen of the second application is displayed may be different from a velocity at which the flexible display moves.

According to an embodiment of the disclosure, the third area may be disposed below the second area.

According to an embodiment of the disclosure, the displaying of the execution screen of the second application in the third area may include increasing a size of the third area, based on moving the top of the third area upward from the bottom of the display area.

According to an embodiment of the disclosure, a velocity at which the execution screen of the second application is displayed in the third area may be higher than the velocity at which the flexible display moves.

According to an embodiment of the disclosure, the displaying of the execution screen of the second application in the third area may include increasing a size of the third area, based on moving at least a portion of the third area from at least one of a left end or a right end of the third area.

According to an embodiment of the disclosure, a direction in which the execution screen of the second application is displayed in the third area is different from a direction in which the flexible display moves.

According to an embodiment of the disclosure, the displaying of at least a portion of the execution screen of the first application or the simplified screen of the execution screen of the first application in the second area may include reducing the size of the second area in which the execution screen of the first application is displayed while the size of the third area in which the execution screen of the second application is displayed increases.

According to an embodiment of the disclosure, the displaying of at least a portion of the execution screen of the first application or the simplified screen of the execution screen of the first application in the second area may include causing a partial area of the execution screen of the first application to gradually disappear while the size of the second area is reduced.

According to an embodiment of the disclosure, the displaying of at least a portion of the execution screen of the first application or the simplified screen of the execution screen of the first application in the second area may include displaying the remaining partial area, excluding the partial area, of the execution screen of the first application or the simplified screen, based on completion of the reduction in the size of the second area.

According to an embodiment of the disclosure, the simplified screen may include a screen obtained by changing an image included in the execution screen of the first application, based on the second area, or a screen obtained by changing a preview screen, based on the second area.

According to an embodiment of the disclosure, the displaying of the execution screen of the second application in the third area may include displaying a partial area of the execution screen of the second application so as to overlap a partial area of the execution screen of the first application while the size of the third area in which the execution screen of the second application is displayed increases.

According to an embodiment of the disclosure, the method of controlling an electronic device may further include displaying a boundary between the second area and the third area, based on completion of the increase in the size of the third area in which the execution screen of the second application is displayed.

According to an embodiment of the disclosure, the method of controlling an electronic device may further include displaying at least one UI for controlling at least one of the execution screen of the first application or the execution screen of the second application in a partial area of the boundary.

According to an embodiment of the disclosure, the at least one UI may include at least one of a UI for switching positions of the execution screen of the first application and the execution screen of the second application, a UI for changing the second execution screen of the second application to a home screen, or a UI for changing the execution screen of the second application to an execution screen of a recently used application.

According to an embodiment of the disclosure, in a non-transitory computer-readable recording medium storing one or more programs, the one or more programs may include instructions that cause an electronic device to display an execution screen of a first application in a first area of a flexible display when the display area is in the first size.

According to an embodiment of the disclosure, the one or more programs may include instructions that cause an electronic device to display at least a portion of the execution screen of the first application or a simplified screen of the execution screen of the first application in a second area including at least a portion of the first area while the display area is changed from the first size to a second size.

According to an embodiment of the disclosure, the one or more programs may include instructions that cause an electronic device to display an execution screen of a second application in a third area including at least a portion of the display area newly visible from the outside of the electronic device while the display area is changed from the first size to the second size.

According to an embodiment of the disclosure, a velocity at which the execution screen of the second application is displayed may be different from a velocity at which the flexible display moves.

According to an embodiment of the disclosure, the third area may be disposed below the second area.

According to an embodiment of the disclosure, the one or more programs may include instructions that cause an electronic device to increase a size of the third area, based on moving the top of the third area upward from the bottom of the display area.

According to an embodiment of the disclosure, a velocity at which the execution screen of the second application is displayed in the third area may be higher than the velocity at which the flexible display moves.

According to an embodiment of the disclosure, the one or more programs may include instructions that cause an electronic device to increase a size of the third area, based on moving at least a portion of the third area from at least one of a left end or a right end of the third area.

According to an embodiment of the disclosure, a direction in which the execution screen of the second application is displayed in the third area is different from a direction in which the flexible display moves.

According to an embodiment of the disclosure, the one or more programs may include instructions that cause an electronic device to reduce the size of the second area in which the execution screen of the first application is displayed while the size of the third area in which the execution screen of the second application is displayed increases.

According to an embodiment of the disclosure, the one or more programs may include instructions that cause an electronic device to cause a partial area of the execution screen of the first application to gradually disappear while the size of the second area is reduced.

According to an embodiment of the disclosure, the one or more programs may include instructions that cause an electronic device to display the remaining partial area, excluding the partial area, of the execution screen of the first application or the simplified screen, based on completion of the reduction in the size of the second area.

According to an embodiment of the disclosure, the simplified screen may include a screen obtained by changing an image included in the execution screen of the first application, based on the second area, or a screen obtained by changing a preview screen, based on the second area.

According to an embodiment of the disclosure, the one or more programs may include instructions that cause an electronic device to display a partial area of the execution screen of the second application so as to overlap a partial area of the execution screen of the first application while the size of the third area in which the execution screen of the second application is displayed increases.

According to an embodiment of the disclosure, the one or more programs may include instructions that cause an electronic device to display a boundary between the second area and the third area, based on completion of the increase in the size of the third area in which the execution screen of the second application is displayed.

According to an embodiment of the disclosure, the one or more programs may include instructions that cause an electronic device to display at least one UI for controlling at least one of the execution screen of the first application or the execution screen of the second application in a partial area of the boundary.

According to an embodiment of the disclosure, the at least one UI may include at least one of a UI for switching positions of the execution screen of the first application and the execution screen of the second application, a UI for changing the second execution screen of the second application to a home screen, or a UI for changing the execution screen of the second application to an execution screen of a recently used application.

According to an embodiment of the disclosure, a ratio of a horizontal length and a vertical length of the second area may be a reciprocal of a ratio of a horizontal length and a vertical length of the third area in the state where increasing a size of the third area, where the execution screen of the second application is displayed, is completed.

According to an embodiment of the disclosure, the electronic device may further include a front camera.

According to an embodiment of the disclosure, the electronic device may further include a rear camera.

According to an embodiment of the disclosure, the one or more programs may include instructions that cause an electronic device to display a preview screen of the execution screen of the front camera or the execution screen of the rear camera in the second area, based on the execution screen of the first application displayed in the first area being the execution screen of the front camera or the execution screen of the rear camera.

According to an embodiment of the disclosure, the one or more programs may include instructions that cause an electronic device to display the remaining one of the execution screen of the front camera or the execution screen of the rear camera, as the execution screen of the second application, in the third area.

According to an embodiment of the disclosure, the execution screen of the second application may be a home screen.

According to an embodiment of the disclosure, the one or more programs may include instructions that cause an electronic device to change the display area from the first size to the second size, based on receiving a user input for adjusting the size of the display area and executing a multi-window function when the display area is in the first size.

According to an embodiment of the disclosure, the one or more programs may include instructions that cause an electronic device to display a notification message in the state in which the execution screen of the first application is displayed in the first area.

According to an embodiment of the disclosure, the one or more programs may include instructions that cause an electronic device to change the display area from the first size to the second size, based on receiving the user input in the state in which the notification message is displayed.

According to an embodiment of the disclosure, the one or more programs may include instructions that cause an electronic device to display the execution screen of the second application related to the notification message in the third area.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities, and some of the multiple entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to an embodiment of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing;
a flexible display in which a size of a display area visible from outside of the electronic device is variable from a first size to a second size based on moving of at least part of the housing; and
at least one processor including processing circuitry; and memory storing instructions that, when executed by the at least one processor individually or collectively, cause the electronic device to:
display an execution screen of a first application in a first area of the flexible display in a state that the size of the display area is the first size,
while the display area is changed from the first size to the second size, display at least a portion of the execution screen of the first application or a simplified screen of the execution screen of the first application, in a second area including at least a portion of the first area, and
while the size of the display area is changed from the first size to the second size, display an execution screen of a second application, corresponding to the size of the display area, in a third area including at least a portion of a display area newly visible from the outside of the electronic device,
wherein a velocity at which the execution screen of the second application is displayed, corresponding to the size of the display area, is different from a velocity at which the size of the display area is changed.

2. The electronic device of claim 1,
wherein the third area is disposed below the second area,
wherein the instructions that, when executed by the at least one processor individually or collectively, cause the electronic device to:
increase a size of the third area based on moving a top of the third area from a bottom of the display area upward, and
wherein the velocity, at which the execution screen of the second application is displayed in the third area, corresponding to the size of the display area, is faster than the velocity at which the size of the display area of the flexible display is changed.

3. The electronic device of claim 1,
wherein the third area is disposed below the second area,
wherein the instructions that, when executed by the at least one processor individually or collectively, cause the electronic device to:
increase a size of the third area based on moving at least a portion of the third area from at least one of a left end or a right end of the third area, and
wherein a direction, in which the execution screen of the second application is displayed in the third area, corresponding to the size of the display area, is different from a direction in which the size of the display area of the flexible display changes.

4. The electronic device of claim 1,
wherein the instructions that, when executed by the at least one processor individually or collectively, cause the electronic device to:
while a size of the third area where the execution screen of the second application is displayed is increased, reduce a size of the second area where the execution screen of the first application is displayed,
while the size of the second area is reduced, make a part of the execution screen of the first application gradually disappear, and
based on reducing the size of the second area being completed, display a remaining part, excluding the part, of the execution screen of the first application, or the simplified screen, and
wherein the simplified screen comprises a screen in which an image included in the execution screen of the first application is changed based on the second area, or a screen in which a preview screen is changed based on the second area.

5. The electronic device of claim 1, wherein the instructions that, when executed by the at least one processor individually or collectively, cause the electronic device to:
while a size of the third area, where the execution screen of the second application is displayed, increases, display a part of the execution screen of the second application by overlapping with a part of the execution screen of the first application.

6. The electronic device of claim 5, wherein the instructions that, when executed by the at least one processor individually or collectively, cause the electronic device to:
based on increasing the size of the third area, where the execution screen of the second application is displayed, being completed, display a boundary between the second area and the third area.

7. The electronic device of claim 6,
wherein the instructions that, when executed by the at least one processor individually or collectively, cause the electronic device to:
display at least one user interface (UI) for controlling at least one of the execution screen of the first application or the execution screen of the second application in a partial area of the boundary, and
wherein the at least one UI comprises at least one of:
a UI for changing positions of the execution screen of the first application and the execution screen of the second application,
a UI for changing the execution screen of the second application to a home screen, or
a UI for changing the execution screen to the execution screen to an execution screen of a recently used application.

8. The electronic device of claim 1, wherein a ratio of a horizontal length and a vertical length of the second area is a reciprocal of a ratio of a horizontal length and a vertical length of the third area, in a state that increasing a size of the third area, where the execution screen of the second application is displayed, is completed.

9. The electronic device of claim 1, further comprising:
a front camera; and
a rear camera,
wherein the instructions that, when executed by the at least one processor individually or collectively, cause the electronic device to:
based on the execution screen of the first application displayed in the first area being a screen obtained by the front camera or a screen obtained by the rear camera, display a preview screen of one of the screen obtained by the front camera or the screen obtained by the rear camera in the second area, and
display a remaining one of the screen obtained by the front camera or the screen obtained by the rear camera as the execution screen of the second application in the third area.

10. The electronic device of claim 1, wherein the execution screen of the second application is a home screen.

11. The electronic device of claim 1, wherein the instructions that, when executed by the at least one processor individually or collectively, cause the electronic device to:
based on receiving a user input for adjusting a size of the display area and executing a multi-window function in the state that the display area is the first size, change the display area from the first size to the second size.

12. The electronic device of claim 11, wherein the instructions that, when executed by the at least one processor individually or collectively, cause the electronic device to:
display a notification message in a state that the execution screen of the first application is displayed in the first area,
based on receiving the user input in a state that the notification message is displayed, change the display area from the first size to the second size, and
display the execution screen of the second application related to the notification message in the third area.

13. A method of controlling an electronic device, the method comprising:
displaying an execution screen of a first application in a first area of a flexible display when a size of a display area of the flexible display visible from outside of the electronic device is a first size;
displaying at least a portion of the execution screen of the first application or a simplified screen of the execution screen of the first application in a second area comprising at least a portion of the first area while the display area is changed from the first size to a second size; and
displaying an execution screen of a second application, corresponding to the size of the display area, in a third area comprising at least a portion of the display area newly visible from the outside of the electronic device while the size of the display area is changed from the first size to the second size,
wherein a velocity at which the execution screen of the second application is displayed, corresponding to the size of the display area, is different from a velocity at which the size of the display area of the flexible display is changed.

14. The method of claim 13,
wherein the third area is disposed below the second area,
wherein the displaying of the execution screen of the second application in the third area comprises:
increasing a size of the third area, based on moving a top of the third area upward from a bottom of the display area, and
wherein a velocity at which the execution screen of the second application is displayed, corresponding to the size of the display area, in the third area is higher than the velocity at which the size of the display area of the flexible display is changed.

15. The method of claim 13,
wherein the third area is disposed below the second area,
wherein the displaying of the execution screen of the second application in the third area comprises:
increasing a size of the third area, based on moving at least a portion of the third area from at least one of a left end or a right end of the third area, and
wherein a direction in which the execution screen of the second application is displayed, corresponding to the size of the display area, in the third area is different from a direction in which the size of the display area of the flexible display is changed.

16. The method of claim 13,
wherein the displaying of at least a portion of the execution screen of the first application or the simplified screen of the execution screen of the first application in the second area comprises:
reducing the size of the second area in which the execution screen of the first application is displayed while the size of the third area in which the execution screen of the second application is displayed is increased;
causing a portion of the execution screen of the first application to gradually disappear while the size of the second area is reduced; and
displaying a remaining portion, excluding the portion, of the execution screen of the first application or the simplified screen, based on completion of the reduction in the size of the second area, and
wherein the simplified screen comprises a screen obtained by changing an image included in the execution screen of the first application, based on the second area, or a screen obtained by changing a preview screen, based on the second area.

17. The method of controlling an electronic device of claim 13, wherein the displaying of the execution screen of the second application in the third area comprises:
displaying a portion of the execution screen of the second application so as to overlap a portion of the execution screen of the first application while the size of the third area in which the execution screen of the second application is displayed is increased.

18. The method of claim 13, further comprising:
displaying a boundary between the second area and the third area, based on completion of an increase in the size of the third area in which the execution screen of the second application is displayed.

19. The method of claim 18, further comprising:
displaying at least one user interface (UI) for controlling at least one of the execution screen of the first application or the execution screen of the second application in a partial area of the boundary,
wherein the at least one UI comprises at least one of:
a UI for switching positions of the execution screen of the first application and the execution screen of the second application,
a UI for changing the execution screen of the second application to a home screen, or
a UI for changing the execution screen of the second application to an execution screen of a recently used application.

20. One or more non-transitory computer-readable storage media storing computer-executable instructions that, when executed by one or more processors individually or collectively, cause an electronic device to perform operations, the operations comprising:
displaying an execution screen of a first application in a first area of a flexible display when a display area of the flexible display visible from outside of the electronic device is in a first size;
displaying at least a portion of the execution screen of the first application or a simplified screen of the execution screen of the first application in a second area comprising at least a portion of the first area while the display area is changed from the first size to a second size; and
displaying an execution screen of a second application in a third area comprising at least a portion of the display area newly visible from the outside of the electronic device while the display area is changed from the first size to the second size,
wherein a velocity at which the execution screen of the second application is displayed is different from a velocity at which the flexible display moves.
